(19) United States
(12) Patent Application Publication
(10) Pub. No.: US 2017/0232895 A1
(43) Pub. Date: Aug. 17, 2017

(54) SYSTEM AND METHODS FOR VERIFYING AND MITIGATING DANGER TO OCCUPANTS OF AN UNATTENDED VEHICLE

(71) Applicant: VIEW & RESCUE, LLC, Spokane, WA (US)

(72) Inventors: Randy D. Sines, Spokane, WA (US); Jesus Rogelio Valenzuela Grijalva, Hermosillo (MX); Mario Jorge Galaz Moreno, Hermosillo (MX); Eugene Vamos, Tucson, AZ (US)

(73) Assignee: VIEW & RESCUE, LLC, Spokane, WA (US)

(21) Appl. No.: 15/043,669

(22) Filed: Feb. 15, 2016

(51) Int. Cl. B60R 1/00; B60R 21/01

(52) U.S. Cl. CPC B60R 1/00; B60R 21/01; B60R 2021/0027

(57) ABSTRACT

The present invention relates generally to a device and methods that detect the presence of a life form inside of a vehicle and attempts to rescue the life form in the event certain trigger events are detected. More specifically, the present invention utilizes advanced detection algorithms and communication protocols to minimize the instances of false detection alarms, relieving the emergency responder system from unneeded emergency calls. Furthermore, some embodiments of the devices are capable of autonomous responses to these trigger events and in some circumstances are capable of having emergency responders remotely respond to these trigger events.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TOA JOINT RESEARCH AGREEMENT

Not Applicable

### REFERENCE TO A “SEQUENCE LISTING,” A TABLE, OR A COMPUTER

Not Applicable

### BACKGROUND OF THE INVENTION

(1) Field of Invention

The present invention relates generally to a device and methods that detect the presence of a life form inside of a vehicle and attempts to rescue the life form if certain trigger events are detected. More specifically, the present invention utilizes advanced detection algorithms and communication protocols to minimize the instances of false detection alarms, relieving the emergency responder system from unneeded emergency calls. Furthermore, some embodiments of the devices are capable of autonomous responses to these trigger events and in some circumstances are capable of enabling emergency responders to remotely respond to these trigger events.

(2) Description of Related Art

Being trapped inside of vehicles are unfortunate, tragic consequences of a vehicle-centric society, leading to fatal and non-fatal injury scenarios: babies left inside of hot cars, people injured and/or taken hostage during a car-jacking, and drivers and passengers trapped due to car accidents.

Being trapped inside a vehicle is especially dangerous to babies and young children left behind by a distracted or overwhelmed parent due to exposure to severe vehicle temperatures, either too hot or too cold. A May 2004 report by the National Highway Traffic Safety Administration indicated that approximately twenty-five children per year die as a result of being left or becoming trapped in hot vehicles in the United States. More recent surveys indicate that, on the average, thirty-seven children die in hot cars each year from heat-related deaths after being trapped inside motor vehicles. http://noheatstroke.org, last seen Jan. 26, 2015. The conditions for hyperthermia, the overheating of the body, is not uncommon. Even at relatively cool ambient temperatures, the temperature rise in vehicles is significant on clear, sunny days. McLaren, Catherine, et al. Heat Stress From Enclosed Vehicles: Moderate Ambient Temperatures Cause Significant Temperature Rise in Enclosed Vehicles, Pediatrics, Vol 116, No. 1, e109-e112 (2005). Vehicles heat up rapidly, with the majority of the temperature rise occurring within the first 15 to 30 minutes. Id. Leaving the windows opened slightly does not significantly slow the heating process or decrease the maximum temperature attained. Id.

Car-jackings became a criminal fixture in the 1980's. Between 1993-2002, about 34,000 carjacking incidents occurred annually, some having more than one victim. About 45% of these incidents were completed crimes. National Crime Victimization Survey, Crime Data Brief Carjacking 1992-2003, Bureau of Justice Statistics (July 2004). These incidents unfortunately continue today. When a car-jacking occurs, the victims have limited options.

Previous life form detection and rescue devices were developed to detect and rescue individuals trapped inside a vehicle. These life form detection and rescue devices range from weigh sensors in baby seats, motion detection sensors, magnetic field sensors, and heart beat sensors, to name a few. These life form detection and rescue devices offer alarms that can alert someone with a key FOB, sound car alarms or even contact an emergency responder. Many of these life form detection and rescue devices are not “all inclusive,” that is, they target a specific subject, for example, babies but often neglect to account for other subjects such as children, animals and the elderly. Information relevant to attempts to address these problems can be found in U.S. Pat. Nos. 5,829,782, 6,329,913, 6,768,420, 6,772,057, 6,847,302, 6,922,147, 6,922,622, 7,106,203, 7,151,452, 7,567,181, 7,676,062, 7,908,777, 8,038,213, 8,212,665, 8,395,511. However, these previous life form detection and rescue devices were designed to be used as a stand-alone system or in a small scale deployment.

Life form detection and rescue devices have the potential to become standard OEM equipment in vehicles. In such scenario, millions of life form detection and rescue devices may be deployed. Hence, life form detection and rescue devices devices need to be designed for large scale, nation-wide implementation. First, life form detection and rescue devices need to minimize detection errors, that is false negatives (no alert when there is a danger situation, “false alarm”) and false positive detections (alert when there is no danger situation). Life form detection and rescue devices with increased false positive errors may overwhelm emergency responders with the sheer number of false alarms that require a response. This either means an overwhelmed system in which true alarms are left un-responded or a costly expanded emergency system enlarged to respond to these false alarms. Furthermore, these solutions must not fail in detecting an actual situation; that is, as close to zero false negatives as possible. Hence, there is a need for life form detection and rescue devices that will both reduce false negatives and false positives to a level that enable large scale deployment. Second, the life form detection and rescue devices need to enable the rescuing of the life form in a fast, timely manner given the time sensitivity of the emergency. The life form detection and rescue devices cannot create situations where the rescuing of a life form is delayed. The response to the Alert needs to be measured in minutes, if not seconds. Third, the life form detection and rescue devices need to allow for fail-safe and redundant paths for rescuing of a life form in the event the primary means is not available.

Previous life form detection and rescue devices do not address these large scale implementation requirements and thus suffer from at least one of the following disadvantages: 1) increased false negative and false positive alert detections, 2) untimely, delayed emergency response, or 3) lack of fail-safe and redundant means for rescuing of a life form.

Previous life form detection and rescue devices have inflated false negative and false positive alert detections. Current motion and image recognition systems are prone to image detection artifacts ranging from insects, shadows, lighting effects, and moving cloud cover. Hence, the use of current sensing technology leads to increased false negative detections. Detection algorithms such as edge detection have been utilized to identify human shapes inside of vehicles. However, improved detection algorithms need to be employed to decrease false positive and false negative detections. Even with improved detection algorithms, there may still be too many alerts to which emergency responders need to respond. A secondary detection step, alert verification, may ensure that false negative detections are minimized further so that the emergency system is not overwhelmed. This alert verification may be implemented by having humans review data describing the emergency situation before engaging emergency responders to arrive at the scene of the emergency situation.

Previous life form detection and rescue devices are designed to create an untimely, delayed emergency response. Some previous life form detection and rescue devices merely provide an alert if an emergency situation is detected. Given the time sensitive nature of these emergency situations, immediate action is required while emergency responders arrive at the scene of the emergency situation; an alert is not enough. In some cases, the alert is not responded because nobody is present to respond to the alert, the key FOB is left in the glove compartment, or the cell phone is discharged.

Previous life form detection and rescue devices lack fail-safe and redundant means for rescuing a life form. Previous life form detection and rescue devices are designed so that one entity controls (e.g. a computer) the rescue of a life form if an emergency situation is detected. However, having the possibility that two entities (a computer and a human being) control the rescue of a life form, either in a fail-safe or a redundant configuration, ensures that a life form rescue attempt is successful. There are a number of life form detection and rescue devices that lack fail-safe and redundant configuration including: Shieh (U.S. Pat. No. 7,151,452—describes a vehicle occupant sensing system but does not describe how a timely emergency response is performed nor does it describe fail-safe and redundant rescue means); Breed (U.S. Pat. No. 5,829,782—describes a vehicle interior identification and monitoring system but does not describe fail-safe and redundant rescue means); McCarthy (U.S. Pat. No. 6,768,420—describes a vehicle compartment occupancy detection system, describes multiple alert paths but does not describe multiple rescue paths. An on-board rescue path is described but a remote rescue path is not. McCarthy '420 does not describe fail-safe and redundant rescue means); Dulin (U.S. Pat. No. 6,922,622—describes a vehicle compartment occupancy detection system, describes multiple alert paths but does not describe fail-safe and redundant rescue means. Dulin '622 describes an on-board rescue means but does not describe fail-safe and redundant rescue means); and Breed (U.S. Pat. No. 7,676,062, describes a vehicle compartment occupancy detection system, describes multiple alert paths but does not describe fail-safe and redundant rescue means. An on-board rescue path is described but a remote rescue path is not. Breed '062 describes an on-board rescue means but does not describe fail-safe and redundant rescue means).

### BRIEF SUMMARY OF THE INVENTION

The invention is a device for rescuing a life form inside of a vehicle (200). The Device (200) monitors the inside of a vehicle (101) and when a Trigger Event is detected, the Device (200) directs Rescue Response Procedures designed to rescue a life form (103). A first instance of the invention is a Monitoring Device for detecting and rescuing a life form inside of a vehicle (210). A second instance of the invention is a Distress Event Monitoring Device for rescuing a life form inside of a vehicle (240).

A Means for Indicating a Distress Event (170) may be referred to in this Specification and in the attached Claims as an Indicating Means (170).

A Means for Resetting Rescue Sequence (172) may be referred to in this Specification and in the attached Claims as a Resetting Means (172).

A Means for Communicating Data to be detected by and from an alert device (174) may be referred to in this Specification and in the attached Claims as a Communicating Means (174).

A Means for Detecting a Life Form (175) may be referred to in this Specification and in the attached Claims as a Detecting Means (175).

A first embodiment (176) of the Detecting Means may be referred to in this Specification and in the attached Claims as a First Detecting Means (176).

A second embodiment (177) of the Detecting Means may be referred to in this Specification and in the attached Claims as a Second Detecting Means (177).

A third embodiment (178) of the Detecting Means may be referred to in this Specification and in the attached Claims as a Third Detecting Means (178).

A fourth embodiment (179) of the Detecting Means may be referred to in this Specification and in the attached Claims as a Fourth Detecting Means (179).

A device for rescuing a life form inside of a vehicle (200) may be referred to in this Specification and in the attached Claims as a Device (200).

A historical record (128) of the Video Feed may be referred to in this Specification and in the attached Claims as a Historical Video Feed (128).

A monitoring device for detecting and rescuing a life form inside of a vehicle (210) may be referred to in this Specification and in the attached Claims as a Monitoring Device (210).

An autonomous monitoring device for detecting and rescuing a life form inside of a vehicle (220) may be referred to in this Specification and in the attached Claims as an Autonomous Monitoring Device (220).

A human supervised monitoring device for detecting, verifying and rescuing a life form inside of a vehicle (230) may be referred to in this Specification and in the attached Claims as a Human Supervised Monitoring Device (230).

A distress event monitoring device for rescuing a life form inside of a vehicle (240) may be referred to in this Specification and in the attached Claims as a Distress Event Monitoring Device (240).

### BRIEF DESCRIPTION OF THE SEVERAL VIEWS OF THE DRAWING

FIG. 1 is an inside side view of a vehicle (101) with two life forms (103) occupying the inside of the vehicle (101). Three Surveillance Cameras (126) monitor different parts of the inside of the vehicle (101). An internal temperature sensor (122) monitors the temperature of the inside of the vehicle (101). A GPS Locator (124) is located within the vehicle (101).

FIG. 2 is a schematic drawing of a first embodiment (195) of the Communicating Means.

FIG. 3 is a schematic drawing of a second embodiment (197) of the Communicating Means.

FIG. 4A is a schematic drawing of a third embodiment (199) of the Communicating Means. A Communication Terminal (190) is operatively connected to a Central Controller (110). A Transmitter/Receiver Apparatus (192) is operatively connected to the Communication Terminal (190). An Antenna (194) is operatively connected to the Transmitter/Receiver Apparatus (192).

FIG. 4B shows a first alert responder (106) viewing a first Alert Device (105) and examining the data sent by the third embodiment (199) of the Communicating Means. FIG. 4B also shows a second alert responder (106) viewing a second Alert Device (105) and examining the data sent by the third embodiment (199) of the Communicating Means.

FIG. 5 is a schematic drawing of the flow of data to and from the Communicating Means (174) and the Alert Device (105). The flow of data includes a Video Feed (127), Outbound Alert Data (180) and Inbound Alert Data (182). The Outbound Alert Data (180) comprises Internal Temperature Data (123) and GPS Location Data (125). The Communicating Means (174) transmits the Video Feed (127) and the Inbound Alert Data (182) to the Alert Device (105). The Communicating Means receives the Inbound Alert Data (182) from the Alert Device (105).

FIG. 6 is a schematic drawing of the flow of data through the Central Controller (110) to the Communicating Means (174). The Surveillance Camera (126) communicates the Video heed (127), an Internal Temperature Sensor (122) communicates the Internal Temperature Data (123), and the GPS Locator (124) communicates the GPS Location Data (125) to the Central Controller (110).

FIG. 7 is an inside view of the front part of the vehicle (101) with the life form (103) occupying the inside of the vehicle showing a Resetting Means (172). The Resetting Controller (160) is operatively connected to a Resetting Button Sensor (162), an Ignition Switch Activation Sensor (163), and a Breaking/Acceleration Pedals Sensor (164). Two Surveillance Cameras (126) and the Internal Temperature Sensor (122) monitor the inside of the vehicle (101).

FIG. 8 is a schematic drawing of a first embodiment (222) of the Autonomous Monitoring Device. The Central Controller (110) is operatively connected to a Vehicle Status Sensor Set (120), the Surveillance Camera (126), the Communicating Means (174) and the Resetting Means (172). The Central Controller (110) comprises an On-Board Clock (118) and a Detecting Means (175).

FIG. 9 is a schematic drawing of a Vehicle Accessory Controller (130) with various sub-controllers operatively connected to various vehicle systems.

FIG. 10 is a schematic drawing of a second embodiment (224) of the Autonomous Monitoring Device. The Central Controller (110) is operatively connected to the Vehicle Status Sensor Set (120), the Vehicle Accessory Controller (130), the Surveillance Camera (126) and the Resetting Means (172).

FIG. 11 is a schematic drawing of a third embodiment (226) of the Autonomous Monitoring Device. The Central Controller (110) is operatively connected to the Vehicle Status Sensor Set (120), the Vehicle Accessory Controller (130), the Surveillance Camera (126), the Communicating Means (174) and the Resetting Means (172).

FIG. 12 shows an Indicating Means (170). It is an inside view of the front part of the vehicle (101) with the life form (103) occupying the inside of the vehicle (101). The Indicating Means (170) is located inside of the vehicle (101). The Distress Controller (165) is operatively connected to the Voice Activated Distress Sensor (149), the Window Breaking Sensor (166), the Ignition Tampering Sensor (167), the Airbag Deployment Sensor (161), and the Distress Button (168). Two Surveillance Cameras (126) monitor the inside of the vehicle (101). Two Surveillance Cameras (126) monitor the inside of the vehicle (101).

FIG. 13 is a schematic drawing of the flow of data to and from the Communicating Means (174) and the Alert Device (105). The flow of data includes the Video Feed (127), a Historical Video Feed (128), Outbound Distress Data (184) and Inbound Alert Data (182). The Outbound Distress Data (184) comprises Vehicle Description Data (188) and the GPS Location Data (125). The Communicating Means (174) transmits the Video Feed (127), the Historical Video Feed (128), and the Outbound Distress Data (184) to the Alert Device (105). The Communicating Means receives the Inbound Alert Data (182) from the Alert Device (105)

FIG. 14 is a schematic drawing of the flow of data through the Central Controller (110) to the Communicating Means (174). The flow of data includes the Video Feed (127), the Historical Video Feed (128), the Outbound Distress Data (184) and the Inbound Alert Data (182). The Outbound Distress Data (184) comprises the Vehicle Description Data (188) and the GPS Location Data (125). The Surveillance Camera (126) communicates the Video Feed (127) to the Central Controller (110). The GPS Locator (124) communicates the GPS Location Data (125) to the Central Controller (110). Memory Circuits (111) communicate the Historical Video Feed (128) to the Central Controller (110). The Central Controller (110) outputs the Outbound Distress Data (184) and communicates the Outbound Distress Data (184) to the Communicating Means (174).

FIG. 15 is a schematic drawing of the data structure of the Vehicle Description Data (188) and sample data. In FIG. 15, the Vehicle Description Data (188) may be comprised of a Vehicle Identification Number-VIN (300), a Vehicle Make (302), a Vehicle Model (304), a Vehicle Color (306), A Vehicle Year (308) or a Vehicle License Plate (310).

FIG. 16 shows a flowchart of an autonomous method for detecting and rescuing a life form inside of a vehicle, utilizing the first embodiment (222) of the Autonomous Monitoring Device.

FIG. 17 shows a flowchart of an autonomous method for detecting and rescuing a life form inside of a vehicle, utilizing the second embodiment (224) of the Autonomous Monitoring Device.

FIG. 18 shows a flowchart of an autonomous method for detecting and rescuing a life form inside of a vehicle, utilizing the third embodiment (226) of the Autonomous Monitoring Device. FIG. 18 also shows a flowchart of the method for rescuing a life form, utilizing the second embodiment (244) of the Distress Event Monitoring Device.

FIG. 19 shows a flowchart of a method for detecting, verifying and rescuing a life form (103) inside of a vehicle, utilizing a Human Supervised Monitoring Device (230).

FIG. 20 is a flow diagram of the Video Feed (127) being analyzed by a Fourth Detecting Means (179) within the Central Controller (110). The Fourth Detecting Means (179) outputs the Outbound Distress Data (184). The Outbound Distress Data (184) comprises the Life Form Recognition Data (186), the Vehicle Description Data (188), the GPS Location Data (125) and the Event Time Data (119).

### DETAILED DESCRIPTION OF THE INVENTION

The invention is a device (200) for rescuing a life form inside of a vehicle. The Device (200) monitors the inside of a vehicle (101). When a Trigger Event is detected, the Device (200) directs Rescue Response Procedures designed to rescue a life form (103). The first instance of the invention is a Monitoring Device for detecting and rescuing a life form inside of a vehicle (210). A second instance of the invention is a Distress Event Monitoring Device for rescuing a life form inside of a vehicle (240).

The life form (103) is any living organism that may conceivably fit inside of the vehicle (101), including human beings, dogs, cats and any other types of living organisms. The Trigger Event is a circumstance from which the life form (103) needs to be rescued. Such Trigger Event may be an accident, a carjacking, or the life form (103) being trapped inside the vehicle (101) where the interior is too hot or too cold. The Rescue Response Procedures are actions utilizing various vehicle systems to rescue the life form (103) by mitigating the Trigger Event, such as cooling the inside of an overheated vehicle, heating the inside of a freezing vehicle, and incapacitating the movement of a car-jacked vehicle.

The Device (200) is designed to respond to these Trigger Events either by having the Device (200) itself direct the Rescue Response Procedures or by having alert responders remotely direct the Rescue Response Procedures through an Alert Device (105). An alert responder (106) is any person, organization, or computer software that responds to the communications communicated from the Device (200) to the Alert Device (105).

The Device (200) may be connected to other vehicle systems to offer a more integrated operation, such as the vehicle's computer system, the vehicle's power system, and the vehicle's screen/video system.

(1) Monitoring Device for Detecting, Verifying, and Rescuing a Life Form Inside of a Vehicle

The first instance of the invention is a monitoring device for detecting and rescuing a life form inside of a vehicle (210). The Monitoring Device (210) is activated when the Trigger Event is detected. For example, the Trigger Event may be detected when the temperature inside of the vehicle reaches a certain threshold and the life form (103) is detected inside of the vehicle (101). The threshold may be an upper threshold to detect a high temperature and/or a lower threshold to detect a low temperature.

A first version of the Monitoring Device is an autonomous monitoring device for detecting and rescuing a life form inside of a vehicle (220). The Autonomous Monitoring Device (220) utilizes a video feed processing algorithm to detect the life form (103) present inside of the vehicle (101) and to rescue the life form (103) by directing the Rescue Response Procedures. It is autonomous in that it relies solely on the video feed processing algorithm for the decisions of its actions and does not depend on human decision-making.

A second version of the Monitoring Device is a human supervised monitoring device for detecting, verifying and rescuing a life form inside of a vehicle (230). The Human Supervised Monitoring Device (230) adds the element of human decision making to verify whether or not the life form (103) is actually present inside of the vehicle (101) and to rescue the life form (103) by directing the Rescue Response Procedures. It is human supervised in that it includes human decision-making for verification and for directing the Rescue Response Procedures.

i) Autonomous Monitoring Device

A first version of the Monitoring Device is an autonomous monitoring device for detecting and rescuing a life form inside of a vehicle (220). The Autonomous Monitoring Device (220) utilizes a video feed processing algorithm to detect if the life form (103) is present inside of the vehicle and to rescue the life form (103) by directing the Rescue Response Procedures. It is autonomous in that it relies solely on the video feed processing algorithm for the decisions of its actions and does not depend on human decision-making.

A first embodiment (222) of the Autonomous Monitoring Device sends an Alert to the Alert Device, if a Trigger Event is Detected (“Detect and Alert”). A second embodiment (224) of the Autonomous Monitoring Device allows for an automated on-board rescue response, if the Trigger Event is detected (“Detect and Rescue”). A third embodiment (226) of the Autonomous Monitoring Device sends the Alert to the Alert Device and allows for an automated on-board rescue response, if the Trigger Event is detected (“Detect, Alert, and Rescue”).

The first embodiment (222) of the Autonomous Monitoring Device sends an Alert to the Alert Device, if a Trigger Event is Detected (“Detect and Alert”). The first embodiment (222) of the Autonomous Monitoring Device comprises a Central Controller (110), a Vehicle Status Sensor Set (120), a Surveillance Camera (126), a Video Feed (127), Outbound Alert Data (180), a Communicating Means (174) and a Resetting Means (172).

The Surveillance Camera (126) monitors the inside of the vehicle (101) and outputs the Video Feed (127). The Surveillance Camera (126) is mounted inside of the vehicle (101) in a location where the Surveillance Camera (126) can monitor the life form (103). The optical data that the Surveillance Camera (126) outputs while monitoring the inside of the vehicle (101) is the Video Feed (127). The Video Feed (127) can either be in a digital or analog format. In an analog format, the Video Feed (127) comprises a stream of still images. In a digital format, the Video Feed (127) comprises a stream of compressed or uncompressed optical data. Compressed optical data may be prepared through either lossy data compression or lossless data compression. A stream of still digital images may also be considered within the definition of the Video Feed (127). The Video Feed (127) may also include audio data.

More than one Surveillance Camera (126) may be deployed to ensure increased coverage of the inside of the vehicle (101). The Surveillance Camera (126) is operatively connected to the Central Controller (110). The Video Feed (127) is communicated to the Central Controller (110). For example, the Surveillance Camera (126) may communicate the Video Feed (127) to the Central Controller (110) via a wired connection or a wireless connection.

The Vehicle Status Sensor Set (120) provides data to the Central Controller (110) regarding the environment inside and outside of the vehicle, such as the location of vehicle, temperature, pressure, elevation, and inclination. The Vehicle Status Sensor Set (120) may include an Internal Temperature Sensor (122) or a GPS Locator (124). The Internal Temperature Sensor (122) senses temperature and outputs Internal Temperature Data (123). The Internal Temperature Sensor (122) is located inside of the vehicle (101), in a place where it can accurately sense the temperature of the surrounding area of the life form (103) inside of the vehicle (101). There may be more than one Internal Temperature Sensor (122). The Internal Temperature Data (123) is communicated to the Central Controller (110). The GPS Locator (124) is a navigation device that calculates geographical location by receiving data from GPS satellites. The GPS Locator (124) outputs GPS Location Data (125). The GPS Location Data (125) is communicated to the Central Controller (110). The members of the Vehicle Status Sensor Set (120) are operatively connected to the Central Controller (110).

The Central Controller (110) directs the various elements of the Device (200) as it detects and rescues the life form (103). The Central Controller (110) is a micro-processor which receives data obtained from the inside of the vehicle. From the data obtained from the inside of the vehicle, the Central Controller (110) determines if the Trigger Event is present. If the Trigger Event is present, the Central Controller (110) determines the Rescue Response Procedures and directs the Rescue Response Procedures to rescue the life form (103). The data obtained from inside of the vehicle (101) may be the Video Feed (127), a Historical Video Feed (128), and the data output from the Vehicle Status Sensor Set (120) such as the Internal Temperature Data (123) and the GPS Location Data (125).

The Central Controller (110) comprises a Detecting Means (175). The Central Controller (110) may also further comprise Memory Circuits (111). The Memory Circuits (111) are semiconductor integrated circuits used to store data for immediate use in a digital electronic apparatus. The Memory Circuits (111) are used by the Central Controller (110) to store the Video Feed (127), creating a historical record (128) of the Video Feed. It may be important for alert responders (106) to obtain and analyze the Historical Video Feed (128) as the Historical Video Feed (128) may contain data that is not available in the live Video Feed (127). For example, the Historical Video Feed (128) may contain the objects inside of the vehicle (101) at the time the Trigger Event was detected which might not be present at the time the Alert Responder (106) examines the Video Feed (127); The image of the face of a car-jacker might not be present at the time the Alert Responder examines the Video Feed (127)

The Detecting Means (175) processes the Video Feed (127) obtained from the Surveillance Camera (126) and using video feed algorithms, attempts to detect the presence of the life form (103). If a life form (103) is detected, the Detecting Means (175) signals the Central Controller (110).

In a first embodiment (176) of the Detecting Means, the Video Feed (127) obtained from the Surveillance Camera (126) is processed through a Shape Detection Algorithm (112). The Shape Detection Algorithm (112) is an algorithm that finds objects in an image or video sequence; types of the Shape Detection Algorithm (112) include block matching, shape skeletons, moment invariants, log-polar mapping, geographic shape descriptors, boundary profiles, Fourier Descriptors, active shape models and Hough Transforms. The histogram of oriented gradients (“HOG”) is a particular shape detection scheme that is very efficient at detecting shapes; this method is similar to that of edge orientation histograms, scale-invariant feature transform descriptors, and shape contexts, but differs in that it is computed on a dense grid of uniformly spaced cells and uses overlapping local contrast normalization for improved accuracy. HOG is to be used with a SVM classifier for shape recognition. Because the recognition is focused on shape, there is a lesser reliance on motion within the Video Feed (127). Hence, the Shape Detection Algorithm (112) is suitable for non-moving life forms (103) such as babies and sleeping adults. The Shape Detection Algorithm (112) may also recognize non-human life forms such as pets.

In a second embodiment (177) of the Detecting Means, the Video Feed (127) obtained from the Surveillance Camera (126) is processed through a Face Detection Algorithm (116). The Face Detection Algorithm (116) is an algorithm that finds faces in an image or video sequence; types of the Face Detection Algorithm (116) include color detection, motion detection, model-faced tracking, Edge-Orientation Matching, Hausdorff Distance, and weak classifier cascades based on Paul Viola & Michael Jones research’ in the early 2000s. The histogram of oriented gradients (“HOG”) is also suitable for face detection. The Face Detection Algorithm (116) detects a face rather than a generic body shape.

In a third embodiment (178) of the Detecting Means, the Video Feed (127) obtained from the Surveillance Camera (126) is processed through the Face Detection Algorithm (116) and the Shape Detection Algorithm (112).

In a fourth embodiment (179) of the Detecting Means, the Video Feed (127) obtained from the Surveillance Camera (126) is processed through the Face Detection Algorithm (116) and the Shape Detection Algorithm (112). If a face is detected using the Face Detection Algorithm (116), a Face Recognition Algorithm (115) attempts to recognize the detected face. When a face has been detected, it means that a particular object has been associated with a generic face. When a face has been recognized, it means that a particular individual has been associated with the detected face. If the Face Recognition Algorithm (115) recognizes a face, the Fourth Detecting Means (179) can determine if the recognized face forms part of an identified group of life forms, for example, the faces of the family owning the vehicle (101) or the faces of the drivers of the company owning the vehicle (101). If the Fourth Detecting Means (179) does not recognize the faces as part of an identified group of life forms, this may signify that the non-recognized face is an intruder attempting a car theft or a car-jacking. This data is important to determine the circumstances and the appropriate responses to the Trigger Event.

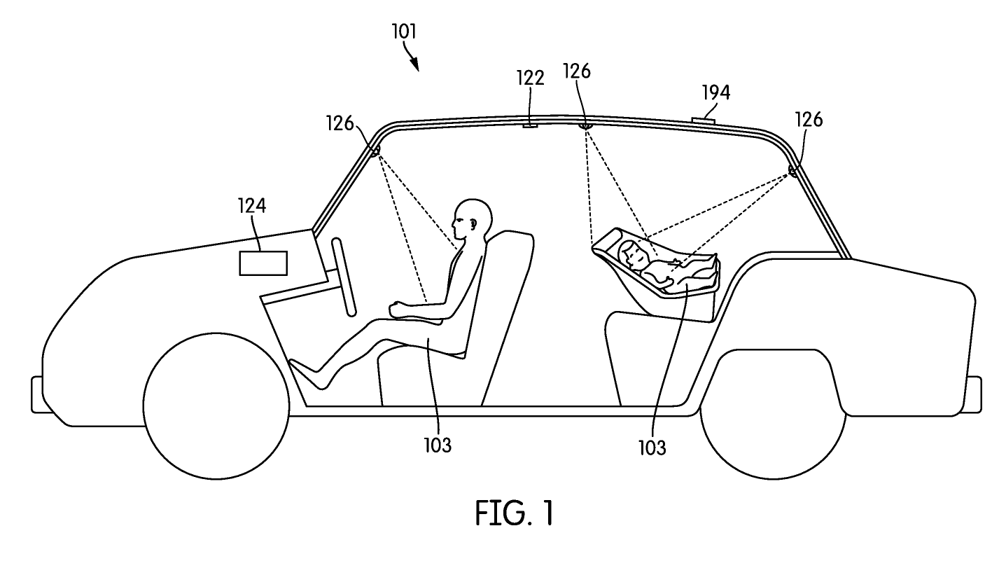

FIG. 1 is an inside side view of the vehicle (101) with two life forms (103) occupying the inside of the vehicle (101). Three Surveillance Cameras (126) monitor different parts of the inside of the vehicle (101). The internal temperature sensor (122) monitors the temperature of the inside of the vehicle (101). The GPS Locator (124) is located within the vehicle (101). FIG. 6 is a schematic drawing of the flow of data through the Central Controller (110) to the Communicating Means (174). The Surveillance Camera (126) communicates the Video Feed (127), the Internal Temperature Sensor (122) communicates the Internal Temperature Data (123), and the GPS Locator (124) communicates the GPS Location Data (125) to the Central Controller (110).

The Device (200) is normally in a Default Monitoring State. In the Default Monitoring State, the Device (200) gathers data from inside of the vehicle (101). The Vehicle Status Sensor Set (120) provides data to the Central Controller (110), and the Surveillance Camera (126) monitors the inside of the vehicle (101).

The Outbound Alert Data (180) comprises data that signals that the Trigger Event has occurred and/or that describes the Trigger Event. The Outbound Alert Data (180) may range from a simple indication that the Trigger Event has occurred to data gathered from the Central Controller (110) and the Vehicle Status Sensor Set (120). For example, the Outbound Alert Data (180) may contain the GPS Location Data (125) and Internal Temperature Data (123). The Central Controller (110) outputs the Outbound Alert Data (180) and communicates the Outbound Alert Data (180) to the Communicating Means (174).

The Outbound Alert Data (180) may also contain Vehicle Description Data (188). The Vehicle Description Data (188) contains information describing the vehicle (101) associated with the Trigger Event. For example, the Vehicle Description Data (188) may be a Vehicle Identification Number-VIN (300), a Vehicle Make (302), a Vehicle Model (304), a Vehicle Color (306), a Vehicle Year (308), a Vehicle License Plate (310), and any additional data type that can help identify the vehicle (101). The Vehicle Description Data (188) maybe used by the alert responders (106) to efficiently locate the vehicle (101) associated with the Trigger Event. The Vehicle Description Data (188) is stored within the Device (200). For example, the Vehicle Description Data (188) maybe stored within the Central Controller (110), and in particular within the Memory Circuits (111). FIG. 15 is a schematic drawing of the data structure of the Vehicle Description Data (188) and sample data. In FIG. 15, the Vehicle Description Data (188) is comprised of the Vehicle Identification Number-VIN (300), the Vehicle Make (302), the Vehicle Model (304), the Vehicle Color (306), the Vehicle Year (308), and the Vehicle License Plate (310).

The Communicating Means (174) is the communication link between the Device (200) and the outside world, utilizing wireless signals and mobile telecommunications technology. For example, the Communicating Means (174) may use 3G, LTE, Wi-Max, RF, microwave, satellite, Bluetooth or any other wireless communication protocol as understood by a person having ordinary skill in the art. The Communicating Means (174) is operatively connected to the Central Controller (110). The Communicating Means (174) can be designed in a number of embodiments.

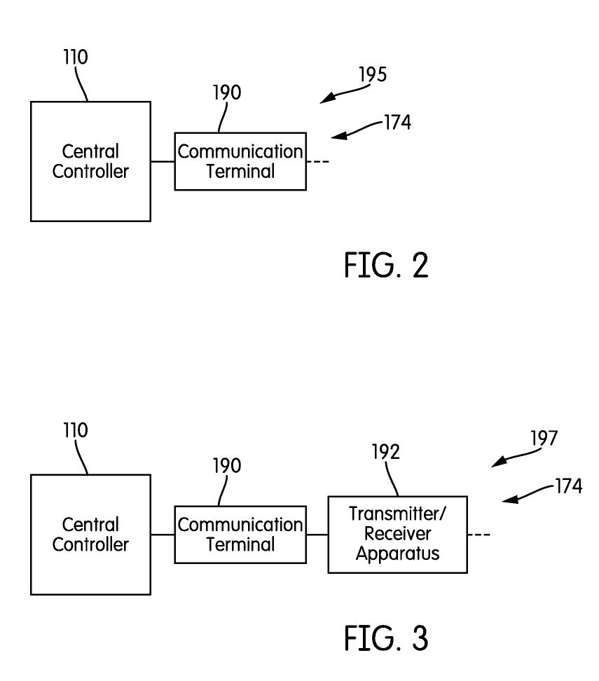

A first embodiment (195) of the Communicating Means connects the Central Controller (110) to the vehicle's communication system. The first embodiment (195) of the Communicating Means allows the Device (200) to be packaged and distributed as Original Equipment Manufacturer (“OEM”) equipment for vehicles or as an aftermarket part. For example, the Device (200) with the first embodiment (195) of the Communicating Means may be installed by auto manufacturers utilizing the vehicle's existing communication system. The first embodiment (195) of the Communicating Means comprises a Communication Terminal (190) operatively connected to the Central Controller (110). The Communication Terminal (190) allows for the operational connectivity between the Central Controller (110) and the vehicle's communication system, such as a Transmitter/Receiver Apparatus (192). Examples of the Communications Terminal (190) include electrical connectors, coaxial RF connectors, ribbon cable connections, and Ethernet connectors. FIG. 2 is a schematic drawing of the first embodiment (195) of the Communicating Means.

A second embodiment (197) of the Communicating Means comprises the Communication Terminal (190) and the Transmitter/Receiver Apparatus (192). The second embodiment (197) of the Communicating Means allows the Device (200) to be packaged and distributed as Original Equipment Manufacturer (“OEM”) equipment for vehicles or as an aftermarket part. For example, the Device (200) with the second embodiment (197) of the Communicating Means may be installed by auto manufacturers utilizing the vehicle's existing communication system. The Transmitter/Receiver Apparatus (192) is electronic circuitry that interfaces the data from the Central Controller (110) with the wireless signal obtained from the vehicle's existing communication system, such as an antenna (194). The Transmitter/Receiver Apparatus (192) can be either a transmitter/receiver or a transceiver. The Communication Terminal (190) is operatively connected to the Central Controller (110). The Transmitter/Receiver Apparatus (192) is operatively connected to the Communication Terminal (190). The vehicle's existing communication system such as the Antenna (194) may be connected to the Transmitter/Receiver Apparatus (192). FIG. 3 is a schematic drawing of the second embodiment (197) of the Communicating Means.

A third embodiment (199) of the Communicating Means comprises the Communication Terminal (190), the Transmitter/Receiver Apparatus (192), and the Antenna (194). Because the third embodiment (199) of the Communicating Means has an integrated design, it is most likely to be packaged and distributed for vehicles which do not have the option to link in to a vehicle's existing communication system or for vehicles that lack a communication system altogether. The Communication Terminal (190) is operatively connected to the Central Controller (110). The Transmitter/Receiver Apparatus (192) is operatively connected to the Communication Terminal (190). The Antenna (194) is operatively connected to the Transmitter/Receiver Apparatus (192) and enables the physical transmission and reception of data to the outside world.

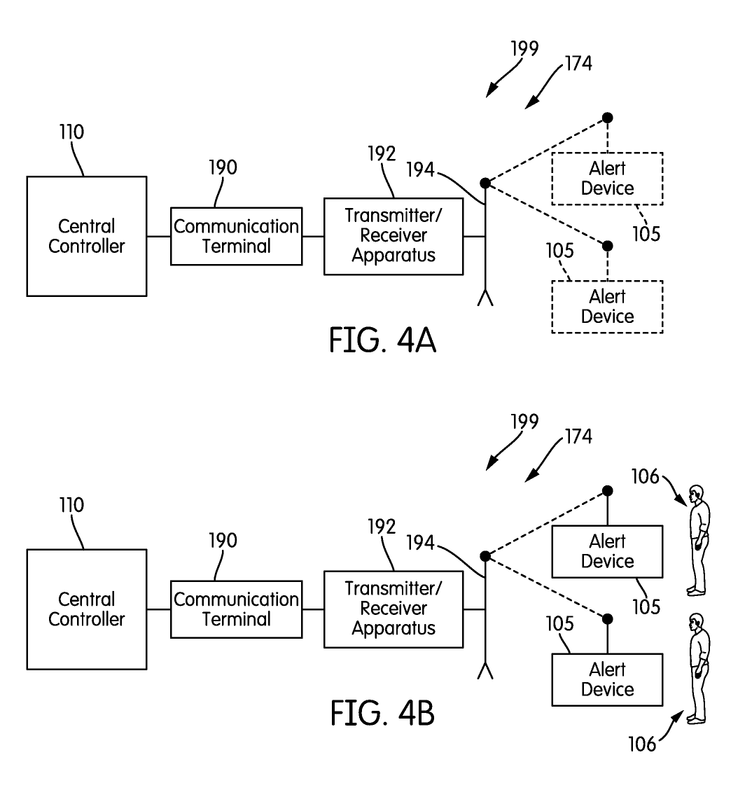

The Communicating Means (174) allows the Central Controller (110) to communicate with the outside world. The Alert Device (105) receives and sends data communicated through the Communicating Means (174). The Communicating Means (174) has the capability of communicating with one or more Alert Devices (105) at a time. FIG. 4A is a schematic drawing of the third embodiment (199) of the Communicating Means communicating with two Alert Devices (105). The Communication Terminal (190) is operatively connected to the Central Controller (110). The Transmitter/Receiver Apparatus (192) is operatively connected to the Communication Terminal (190). The Antenna (194) is operatively connected to the Transmitter/Receiver Apparatus (192).

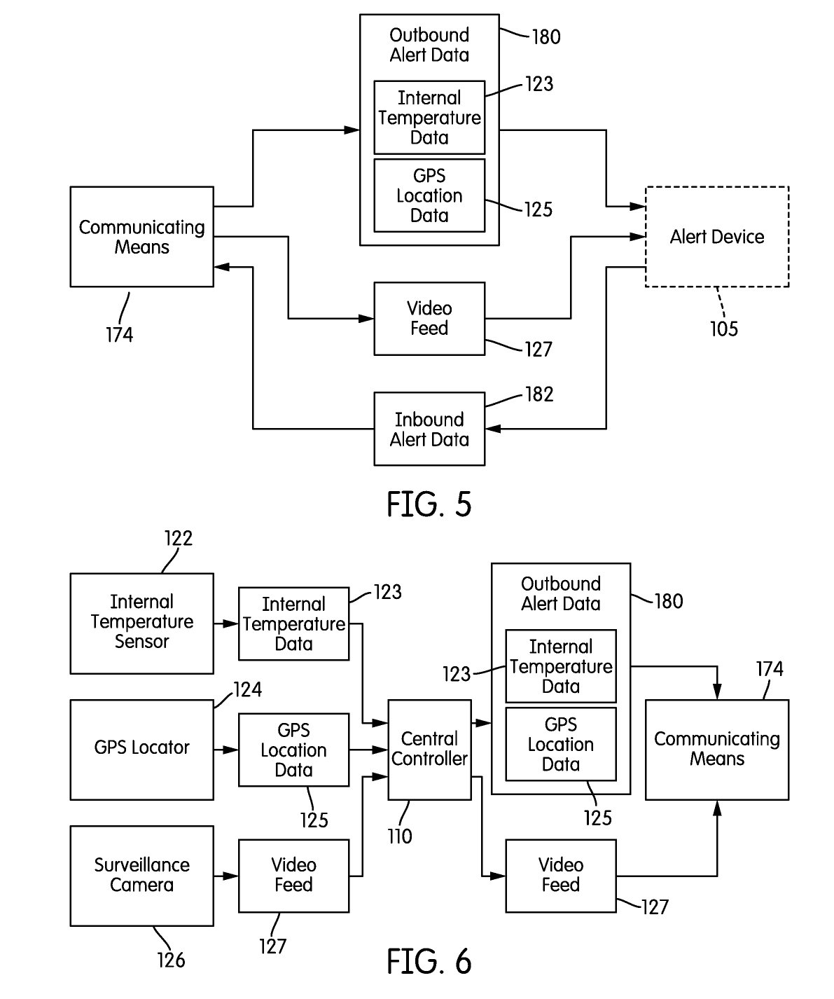

The Alert Device (105) may be any equipment or system capable of interpreting data transmitted from the Communications Means (174). For example, the Alert Device (105) may be a Key FOB, a cell phone, a public 911 system or a private telematics system such as On-Star, StarLink, and BlueLink. The Alert Device (105) may also be a personal computer or a tablet. The data may be communicated directly from the Communication Means (174) to the Alert Device (105) (e.g. Key FOB, Bluetooth receiver) or through a series of interconnected communications networks (e.g. home computer, cell phone, iPad tablet). Data transmitted from the Communicating Means (174) to the Alert Device (105) may include the Outbound Alert Data (180), Video Feed (127), or Historical Video Feed (128). FIG. 5 is a schematic drawing of the flow of data to and from the Communicating Means (174) and the Alert Device (105). The flow of data includes a Video Feed (127), Outbound Alert Data (180) and Inbound Alert Data (182). The Outbound Alert Data (180) comprises Internal Temperature Data (123) and GPS Location Data (125). The Communicating Means (174) transmits the Video Feed (127) and the Inbound Alert Data (182) to the Alert Device (105). The Communicating Means receives the Inbound Alert Data (182) from the Alert Device (105). The Inbound Alert Data (182) are set of commands that the Central Controller (110) utilizes to direct the Rescue Response Procedures.

The data transmitted from the Communicating Means (174) to the Alert Device (105) is examined by the alert responder (106). The alert responder (106) viewing the Alert Device (105) is informed of the Trigger Event as described from the data communicated from the Communicating Means (174). The alert responder (106) may initiate rescue efforts such as sending other alert responders (106) to the location of the vehicle (101) to rescue the life form (103). The alert responder (106) may initiate rescue efforts such as preparing commands that the Central Controller (110) utilizes to direct Rescue Response Procedures and sending the commands as Inbound Alert Data (182) from the Alert Device (105) to the Communicating Means (174).

Once the Central Controller (110) detects the life form (103) inside of the vehicle (101) and directs the Rescue Response Procedures, there is an eventual need to reset the Device to the Default Monitoring State (200) once the Trigger Event is resolved. The Device (200) may be reset to the Default Monitoring State in one of two manners: by activating the Resetting Means (172) within the vehicle (101) or by commands received as part of the Inbound Alert Data (182) through the Communicating Means (174). When the Device (200) is reset to the Default Monitoring State, all previous actions in all the various elements of the Device are terminated and reset. For example, all initiated Rescue Response Procedures are terminated, the Communicating Means (174) communications are terminated, and the Vehicle Status Sensor Set (120), the Surveillance Camera (126) and the Central Controller (110) are reset.

The Resetting Means (172) comprises a Resetting Controller (160) and a Resetting Sensor (401). There maybe more than one Resetting Sensor (401). The Resetting Sensor (401) is operatively connected to the Resetting Controller (160). The Resetting Sensor (401) is operatively connected to a Resetting Device (400). The Resetting Controller (160) communicates a resetting signal to the Central Controller (110) when the Resetting Sensor (401) detects when the Resetting Device (400) has been activated. The Resetting Device (400) is any apparatus inside of the vehicle (101) that may be used to initiate a signal input. For example, the Resetting Device (400) may be a resetting button, an ignition switch, a key switch, or breaking/acceleration pedals. The Resetting Means (172) is operatively connected to the Central Controller (110).

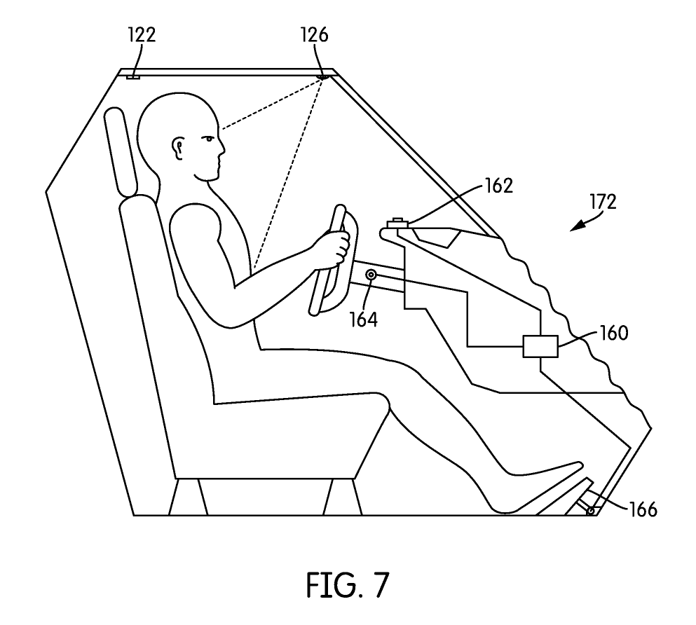

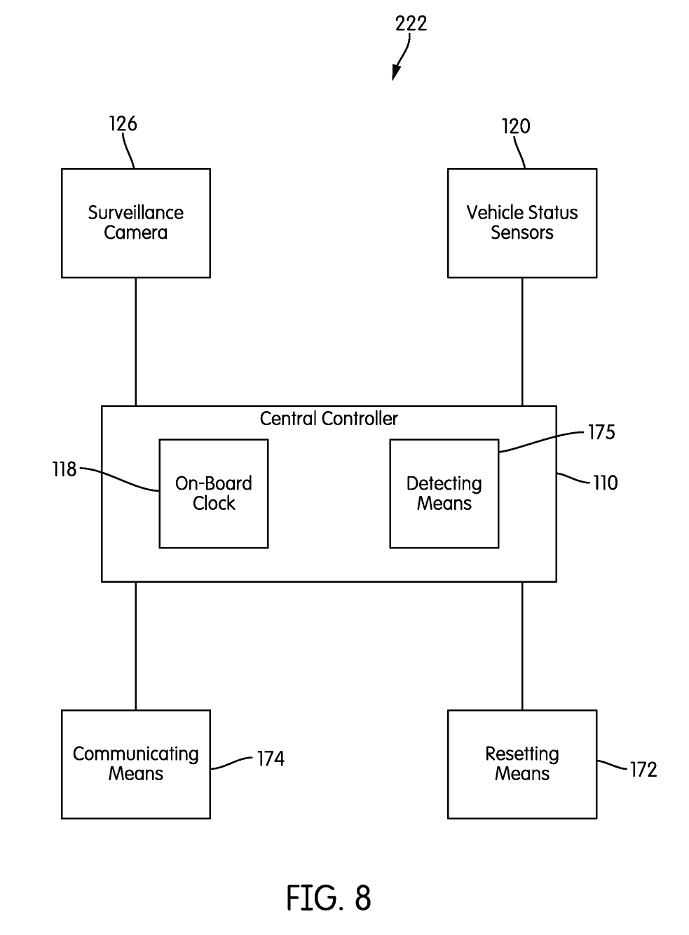

A first embodiment (402) of the Resetting Means has the Resetting Controller (160) operatively connected to a Resetting Button Sensor (162) as the Resetting Sensor (401). The Resetting Button Sensor (162) detects when the resetting button, as the Resetting Device (400), has been activated. A second embodiment (404) of the Resetting Means has the Resetting Controller (160) operatively connected to an Ignition Switch Activation Sensor (163) as the Resetting Sensor (401). The Ignition Switch Activation Sensor (163) detects when the ignition switch, as the Resetting Device (400), has been activated in a specific, pre-determined manner. A third embodiment (406) of the Resetting Means has the Resetting Controller (160) operatively connected to a Breaking/Acceleration Pedals Sensor (164) as the Resetting Sensor (401). The Breaking/Acceleration Pedals Sensor (164) detects when the breaking/acceleration pedals, as the Resetting Device (400), have been activated in a specific, pre-determined manner. If there are more than one Resetting Sensor (162), one or more of the Resetting Sensors (162) may need to be activated for the Resetting Controller (160) to send the resetting signal to the Central Controller (110). FIG. 7 is an inside view of the front part of the vehicle (101) with the life form (103) occupying the inside of the vehicle showing a Resetting Means (172). The Resetting Controller (160) is operatively connected to the Resetting Button Sensor (162), the Ignition Switch Activation Sensor (163), and the Breaking/Acceleration Pedals Sensor (164). Two Surveillance Cameras (126) and the Internal Temperature Sensor (122) monitor the inside of the vehicle (101).

Once the alert responder (106) takes appropriate actions to rescue the life form (103), the alert responder (106) activates the Resetting Means (172) in a pre-determined sequence. Once the Resetting Means (172) is activated, the Device (200) is reset to the Default Monitoring State. If the Resetting Means (172) is the only manner to reset the Device, this ensures that the alert responders (106) need to arrive at the scene of the Trigger Event in order to reset the Device (200); all Trigger Events have to be responded by the alert responder (106). This prevents an accidental or willful remote reset of the Device (200).

The Device (200) may be allowed to be reset by the Inbound Alert Data (182) received through the Communicating Means (174) from the Alert Device (105). This allows for the Device (200) to be reset to the Default Monitoring State without having the alert responders (106) arrive at the scene of the Trigger Event.

The Central Controller (110) may also comprise an On-Board Clock (118), which keeps track of the time and date. Because rescue of the life form (103) locked inside an over-heated or over-cold vehicle is extremely time sensitive, it is imperative to time stamp the detection of the Trigger Event as it unfolds during the detection and rescue of the life form (103). The On-Board Clock (118) outputs the Event Time Data (119), which comprises time and date information. The Central Controller (110) may utilize the Event Time Data (119) to time stamp the detection of the Trigger Event, both as a real time data indicator and a post-event indicator. The Outbound Alert Data (180) may also comprise the Event Time Data (119). The Event Time Data (119) may be used by alert responders (106) to prioritize their response to the Trigger Event. The Event Time Data (119) data may also be useful in insurance, criminal and civil investigations, depending on the nature of the Trigger Event. FIG. 8 is a schematic drawing of the first embodiment (222) of the Autonomous Monitoring Device. The Central Controller (110) is operatively connected to the Vehicle Status Sensor Set (120), the Surveillance Camera (126), the Communicating Means (174) and the Resetting Means (172). The Central Controller (110) comprises the On-Board Clock (118) and the Detecting Means (175).

An autonomous method for detecting and rescuing a life form inside of a vehicle, utilizing the first embodiment (222) of the Autonomous Monitoring Device is described below. The first embodiment (222) of the Autonomous Monitoring Device is normally in the Default Monitoring State, gathering data from inside of the vehicle (101). The Vehicle Status Sensor Set (120) monitors the inside of the vehicle (500). The Vehicle Status Sensor Set (120) communicates data to the Central Controller (110). For example, the Internal Temperature Sensor (122) communicates the Internal Temperature Data (123) to the Central Controller (110). The GPS Locator (124) communicates the GPS Location Data (125) to the Central Controller (110). The Surveillance Camera monitors the inside of the vehicle (505). The Surveillance Camera (126) communicates the Video Feed (127) to the Central Controller (110). The Central Controller (110) evaluates the data communicated to the Central Controller (110). The Vehicle Status Sensor Set (120) and the Surveillance Camera (126) may monitor the inside of the vehicle (101) in a continuous, a periodic, or an event driven manner (e.g. when the Internal Temperature Data has reached a threshold).

If the Central Controller detects that the Trigger Event has occurred (510), the Central Controller directs an On-Board Rescue Sequence (515). In the first embodiment (222) of the Autonomous Monitoring Device, the Trigger Event occurs if the Internal Temperature Data (123) has reached a threshold and if the Detecting Means (175) detects a life form (103). In the event the Trigger Event is not detected (510), the Default Monitoring State is maintained.

When the Central Controller directs the On-Board Rescue Sequence (515), the Central Controller communicates data through the Communicating Means to the Alert Device (525). For example, the data communicated through the Communicating Means (525) maybe at least one of the Video Feed (127), the Outbound Alert Data (180), or the Historical Video Feed (128). The Alert Device (105) receives this data and the alert responder (106), that is, the user of the Alert Device (105), examines this data. The alert responder (106) viewing the Alert Device (105) is informed of the Trigger Event as described by the data that the Alert Device (105) receives. The alert responder (106) may initiate rescue efforts such as sending alert responders (106) to the location of the vehicle to rescue the life form (103). The Central Controller continues directing the On-Board Rescue Sequence (515) until the Resetting Means is activated (545). FIG. 4B shows a first alert responder (106) viewing a first Alert Device (105) and examining the data sent by the third embodiment (199) of the Communicating Means. FIG. 4B also shows a second alert responder (106) viewing a second Alert Device (105) and examining the data sent by the third embodiment (199) of the Communicating Means.

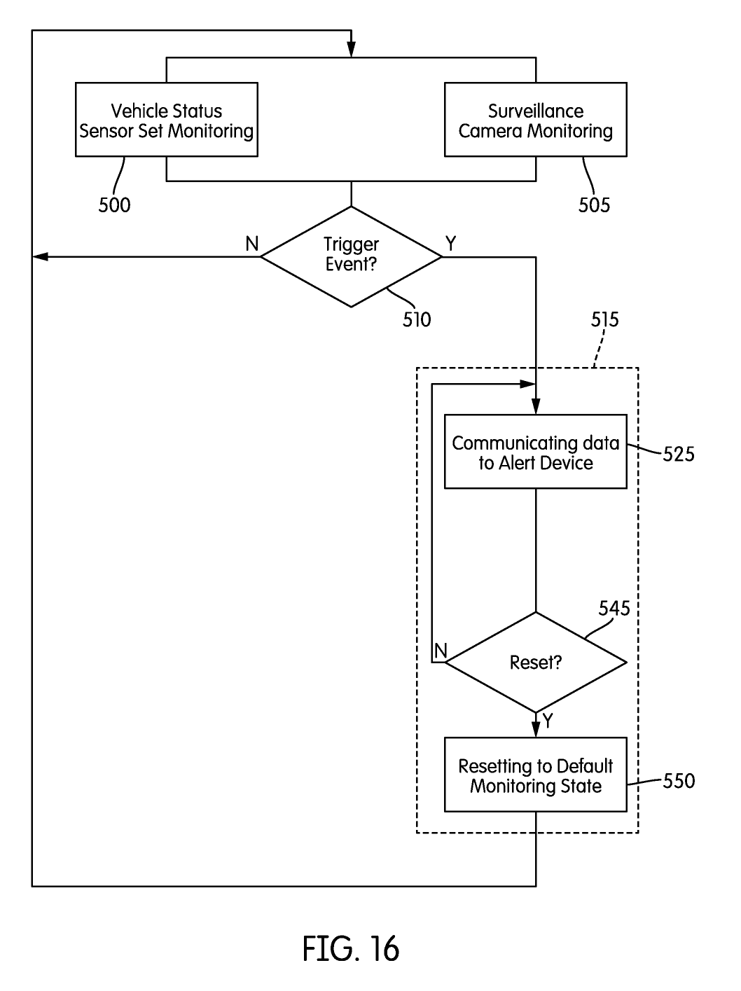

Once the alert responder (106) arrives at the location of the vehicle (101), the alert responder (106) attempts to resolve the Trigger Event and rescue the life form (103). Once the Trigger Event is resolved and the life form (103) has been rescued, the alert responder (106) may activate the Resetting Means (172). In the event the alert responder activates the Resetting Means (545), the Autonomous Monitoring Device is reset to the Default Monitoring State (550). In the event the alert responder does not activate the Resetting Means (545), the Central Controller continues directing the On-Board Rescue Sequence (515). FIG. 16 shows a flowchart of the autonomous method for detecting and rescuing a life form inside of a vehicle, utilizing the first embodiment (222) of the Autonomous Monitoring Device.

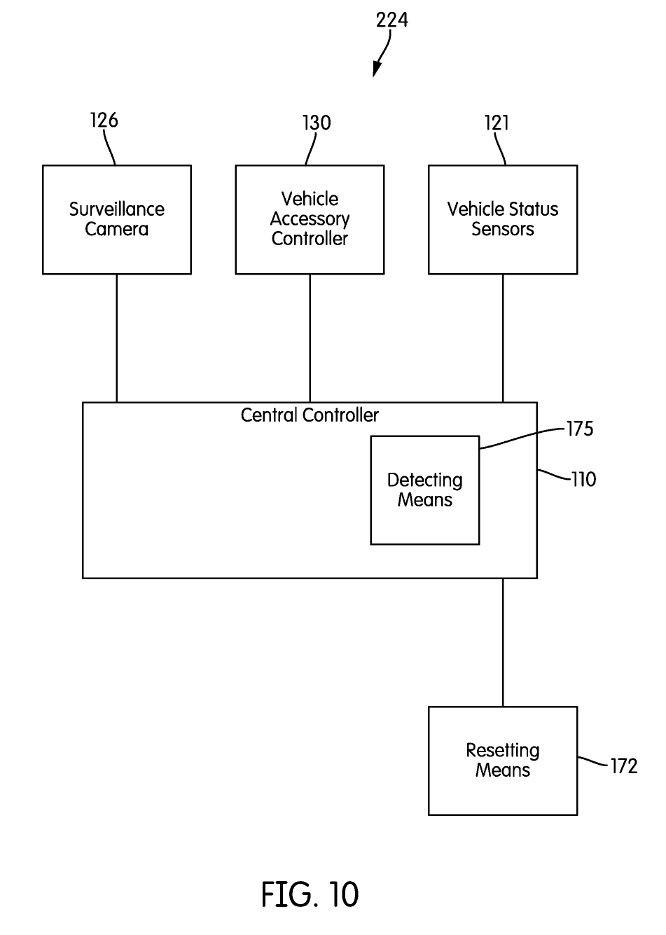

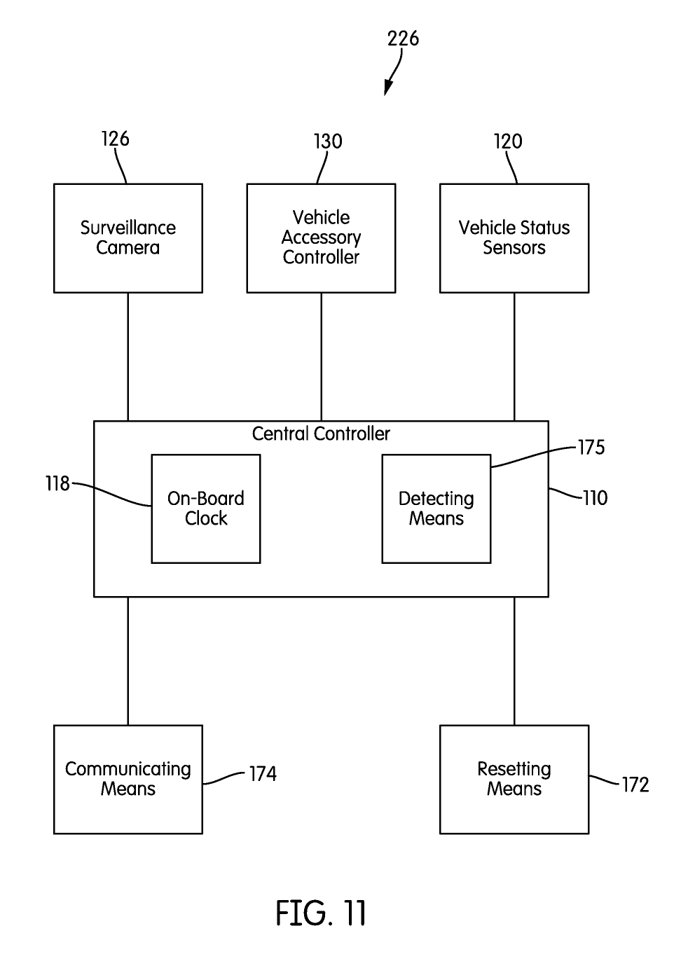

A second embodiment (224) of the Autonomous Monitoring Device allows for an automated on-board rescue response, if the Trigger Event is detected (“Detect and Rescue”). The second embodiment (224) of the Autonomous Monitoring Device comprises the Central Controller (110), the Vehicle Status Sensor Set (120), a Vehicle Accessory Controller (130), the Surveillance Camera (126), the Video Feed (127), and the Resetting Means (172). The Central Controller (110) is operatively connected to the Vehicle Status Sensor Set (120), the Vehicle Accessory Controller (130), the Surveillance Camera (126), the Video Feed (127), and the Resetting Means (172). FIG. 10 is a schematic drawing of the second embodiment (224) of the Autonomous Monitoring Device. The Central Controller (110) is operatively connected to the Vehicle Status Sensor Set (120), the Vehicle Accessory Controller (130), the Surveillance Camera (126) and the Resetting Means (172).

The Vehicle Accessory Controller (130) regulates various vehicle systems that may be used to rescue the life forms (103) inside of the vehicle (101). The Vehicle Accessory Controller (130) is operatively connected to the Central Controller (110). The Vehicle Accessory Controller (130) contains one or more Sub-Controllers that regulate various vehicle systems. The Central Controller (110) directs the Vehicle Accessory Controller (130) and its various Sub-Controllers to regulate various vehicle systems

These Sub-Controllers may include at least one of an Air Conditioning Sub-Controller (132), an Engine Sub-Controller (136), a Windows Sub-Controller (144), a Light Sub-Controller (140), a Sound sub-Controller (148), a Horn Sub-Controller (156), a Lock Sub-Controller (158), or a Heating Controller (152).

The Air Conditioning Sub-Controller (132) is operatively connected to an air conditioning system (134). The Air Conditioning Sub-Controller (132) regulates the operation of the air conditioning system (134) by turning it on, fluctuating its output, and turning it off. With this ability to regulate the air conditioning system (134), the Central Controller (110) can decrease the air temperature inside of the vehicle (101).

The Engine Sub-Controller (136) regulates the operation of a vehicle engine (138) by turning it on and off. The Engine Sub-Controller (136) is operatively connected to the vehicle engine (138). These functions maybe vital to enable for a successful rescue of the life form (103) since the air conditioning system (134) may only operate a limited amount of time before the vehicle batteries run down. When the Engine Sub-Controller (136) turns on the vehicle engine (138), the vehicle engine (138) provides power to the air conditioning system (134) and recharges the vehicle batteries. This function increases the time frame for alert responders (106) to arrive before the life form (103) is adversely impacted by heat.

The Heating Sub-Controller (152) is operatively connected to a vehicle's heating system (154). The Heating Sub-Controller (152) regulates the operation of the vehicle's heating system (154) by turning it on, fluctuating its output, and turning it off. With this ability to regulate the heating system (154), the Central Controller (110) may increase the air temperature inside of the vehicle (101). The Engine Sub-Controller (136) may need to turn on the vehicle engine (138), so that the vehicle engine provides power and heat to the heating system (154). This function increases the time frame for alert responders (106) to arrive before the life form (103) is adversely impacted by cold.

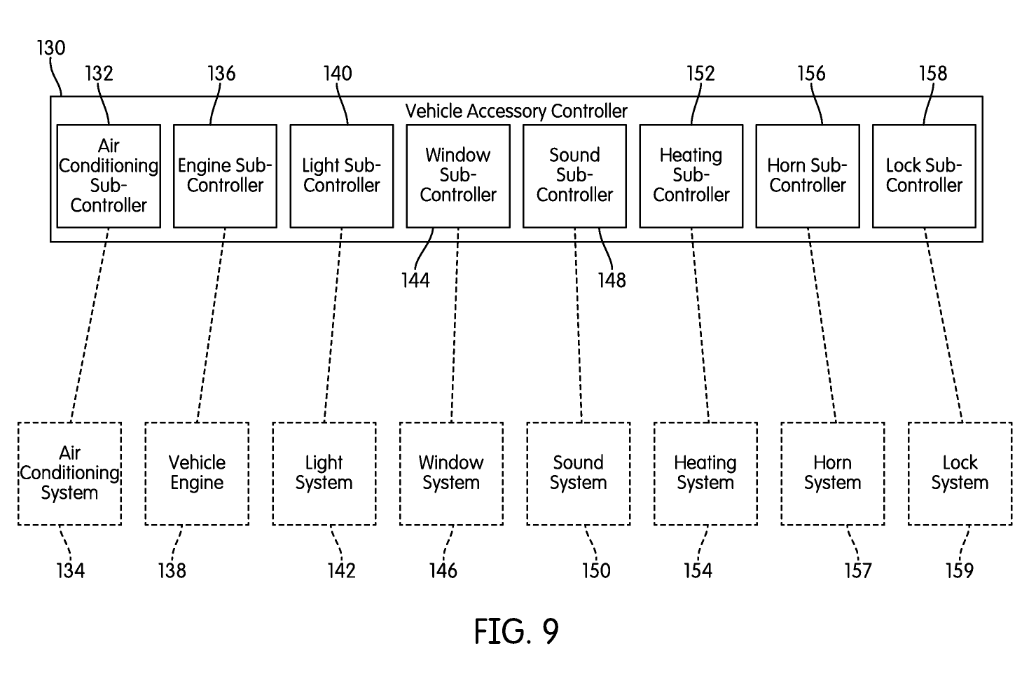

The Windows Sub-Controller (144) may regulate a window system (146), where the window system (146) is comprised of vehicle windows and apparatus to raise and lower the vehicle windows. The Windows Sub-Controller (144) is able to lower and raise these vehicle windows, to lower the inside temperature, to allow for life form escape or to allow for alert responder (106) entry. The Light Sub-Controller (140) regulates a light system (142), where the light system (142) is comprised of the vehicle lights. The Light Sub-Controller (140) is able to turn on/off the light system (142) such as the headlights and taillights so that alert responders (106) may more easily identify the vehicle (101). The Sound Sub-Controller (148) regulates a sound generator (150), where the sound generator (150) is an apparatus that generates various types of sounds. The Sound Sub-Controller is able to turn on/off the sound generator (150) to wake up a sleeping or semi-conscious life form (103). The Horn Sub-Controller (156) regulates a horn system (157), where the horn system (157) is comprised of the vehicle horn. The Horn Sub-Controller (156) is able to turn on and off the horn system (157) such that alert responders (106) may more easily identify the vehicle (101). The Lock Sub-Controller (158) regulates the lock system (159), where the lock system (159) is comprised of the vehicle's door locks. The Lock Sub-Controller (158) is able to lock and unlock the vehicle's door locks, allowing access to the inside of the vehicle to the alert responders (106) in the event that the vehicle's doors were locked as the Trigger Event Occurred. These sub-controllers are operatively connected to their respective vehicle systems. FIG. 9 is a schematic drawing of the vehicle accessory controller (130) with various sub-controllers operatively connected to various vehicle systems.

An autonomous method for detecting and rescuing a life form inside of a vehicle, utilizing the second embodiment (224) of the Autonomous Monitoring Device is described below. The second embodiment (224) of the Autonomous Monitoring Device is normally in the Default Monitoring State, gathering data from inside of the vehicle (101). The Vehicle Status Sensor Set (120) monitors the inside of the vehicle (500). The Vehicle Status Sensor Set (120) communicates data to the Central Controller (110). For example, the Internal Temperature Sensor (122) communicates the Internal Temperature Data (123) to the Central Controller (110). The GPS Locator (124) communicates the GPS Location Data (125) to the Central Controller (110). The Surveillance Camera monitors the inside of the vehicle (505). The Surveillance Camera (126) communicates the Video Feed (127) to the Central Controller (110). The Central Controller (110) evaluates the data communicated to the Central Controller (110). The Vehicle Status Sensor Set (120) and the Surveillance Camera (126) may monitor the inside of the vehicle (101) in a continuous, a periodic, or an event driven manner (e.g. when the Internal Temperature Data has reached a threshold).

If the Central Controller detects that a Trigger Event has occurred (510), the Central Controller directs the On-Board Rescue Sequence (515). In the second embodiment (224) of the Autonomous Monitoring Device, the Trigger Event occurs if the Internal Temperature Data (123) has reached a threshold and if the Detecting Means (175) detects a life form (103). In the event the Trigger Event is not detected (510), the Default Monitoring State is maintained.

When the Central Controller directs the On-Board Rescue Sequence (515), the Central Controller determines the Rescue Response Procedures (535) based on the data collected by the Central Controller and the existence of the various sub-controllers in the Vehicle Accessory Controller. The Rescue Response Procedures are actions utilizing the various vehicle systems that are regulated by the Central Controller (110), the Vehicle Accessory Controller (130) and the Vehicle Accessory Sub-Controllers to mitigate or help assist mitigating the Trigger Event. The Central Controller (110) continues directing the On-Board Rescue Sequence until the Resetting Means (172) is activated.

In one example of the Rescue Response Procedure, the Central Controller (110) regulates the vehicle engine (138) by directing the Engine Sub-Controller (136). The Engine Sub-Controller (136) turns on the vehicle engine (138) when Central Controller (110) detects that the vehicle's battery had been used too long. This provides the Device (200) with a secondary power source and the ability to recharge the vehicle's battery.

In another example of the Rescue Response Procedure, the Central Controller (110) regulates the air conditioning system (134) by directing the Air Conditioning Sub-Controller (132). The Air Conditioning Sub-Controller (132) turns on and regulates the air conditioning system (134) to decrease the temperature in the inside of the vehicle (101) to a suitable level until alert responders (106) arrive to rescue the life form (103).

In another example of the Rescue Response Procedure, the Central Controller (110) regulates the heating system (154) by directing the Heating Sub-Controller (152). The Heating Sub-Controller (152) turns on and regulates the heating system (154) to increase the temperature in the inside of the vehicle (101) to a suitable level until alert responders (106) arrived to rescue the life form (103). The Central Controller (110) may turn on the vehicle engine (138) to provide heat to the heating system (154).

Other examples of the Rescue Response Procedures include: having the Light Sub-Controller (140) turn on and off head lamps from the light system (142), having the Windows Sub-Controller (144) roll up and down windows from the window system (146), having the Sound Sub-Controller (148) directing the sound generator (150) to generate sounds and voices to alert/wake up a sleeping/unconscious life form (103), having the Horn Sub-Controller (156) activate the car horn from the horn system (157), and having the Lock Sub-Controller (158) lock and unlocking car locks from the lock system (159). The availability of these Rescue Response Procedures depends on the existence of the various sub-controllers in the Vehicle Accessory Controller (130).

Once the Central Controller determines Rescue Response Procedures (535) based on the data collected by the Central Controller and the existence of the various sub-controllers in the Vehicle Accessory Controller, the Central Controller directs the Rescue Response Procedures (540).

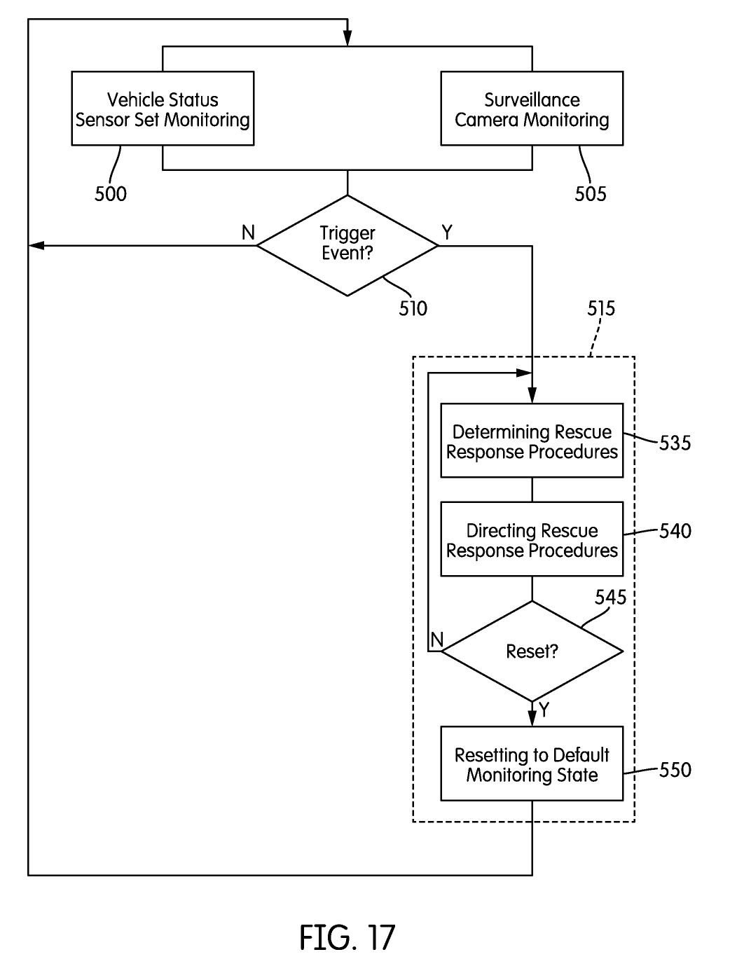

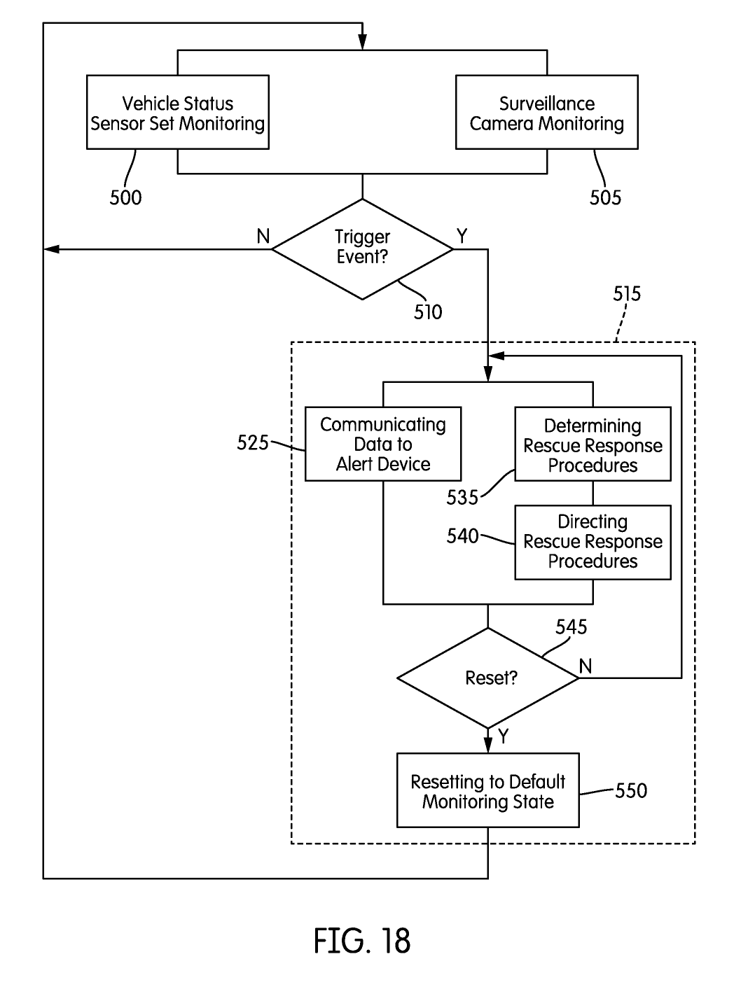

When the alert responder (106) arrives at the location of the vehicle (101), the alert responder (106) attempts to rescue the life form (103). Once the Trigger Event is resolved, and the life form (103) has been rescued, the alert responder (106) may activate the Resetting Means (172). If the alert responder activates the Resetting Means (545), the Autonomous Monitoring Device is reset to the Default Monitoring State (550). If the alert responder does not activate the Resetting Means (545), the Central Controller continues directing the On-Board Rescue Sequence (515). FIG. 17 shows a flowchart of the autonomous method for detecting and rescuing a life form inside of a vehicle, utilizing the second embodiment (224) of the Autonomous Monitoring Device.

A third embodiment (226) of the Autonomous Monitoring Device sends the Alert to the Alert Device and allows for an automated on-board rescue response, if the Trigger Event is detected (“Detect, Alert, and Rescue”). The third embodiment (226) of the Autonomous Monitoring Device comprises the second embodiment (224) of the Autonomous Monitoring Device (224), the Communicating Means (174), and the Outbound Alert Data (180). FIG. 11 is a schematic drawing of the third embodiment (226) of the Autonomous Monitoring Device. The Central Controller (110) is operatively connected to the Vehicle Status Sensor Set (120), the Vehicle Accessory Controller (130), the Surveillance Camera (126), the Communicating Means (174) and the Resetting Means (172). If the Trigger Event is detected by the Central Controller (110), the Central Controller (110) will attempt to communicate data through the Communicating Means (174) and to direct the various vehicle systems that are operatively connected to the Vehicle Accessory Controller (130) to mitigate the Trigger Event.

A method for detecting and rescuing a life form inside of a vehicle, utilizing the third embodiment (226) of the Autonomous Monitoring Device is described below. The third embodiment (226) of the Autonomous Monitoring Device is normally in the Default Monitoring State, gathering data from inside of the vehicle (101). The Vehicle Status Sensor Set monitors the inside of the vehicle (500). The Vehicle Status Sensor Set (120) communicates data to the Central Controller (110). For example, the Internal Temperature Sensor (122) communicates the Internal Temperature Data (123) to the Central Controller (110). The GPS Locator (124) communicates the GPS Location Data (125) to the Central Controller (110). Surveillance Cameras monitors the inside of the vehicle (505). The Surveillance Camera (126) communicates the Video Feed (127) to the Central Controller (110). The Central Controller (110) evaluates the data communicated to the Central Controller (110). The Vehicle Status Sensor Set (120) and the Surveillance Camera (126) may monitor the inside of the vehicle (101) in a continuous, a periodic, or an event driven manner (e.g. when the Internal Temperature Data has reached a threshold).

If the Central Controller detects that a Trigger Event has occurred (510), the Central Controller directs the On-Board Rescue Sequence (515). In the third embodiment (226) of the Autonomous Monitoring Device, the Trigger Event occurs if the Internal Temperature Data (123) has reached a threshold and if the Detecting Means (175) detects a life form (103). In the event the Trigger Event is not detected (510), the Default Monitoring State is maintained.

When the Central Controller directs the On-Board Rescue Sequence (515), the Central Controller (110) performs two simultaneous actions. In the first action, the Central Controller communicates data through the Communicating Means to the Alert Device (525). For example, the data communicated through the Communicating Means (525) at least one of the Video Feed (127), the Outbound Alert Data (180), or the Historical Video Feed (128). The Alert Device (105) receives this data and the alert responder (106), that is, the user of the Alert Device (105), examines this data. The alert responder (106) viewing the Alert Device (105) is informed of a Trigger Event as described by the data that the Alert Device (105) receives. The alert responder (106) may initiate rescue efforts such as sending alert responders (106) to the location of the vehicle (101) to rescue the life form (103).

In the second action, the Central Controller determines the Rescue Response Procedures (535) based on the data collected by the Central Controller and the existence of the various sub-controllers in the Vehicle Accessory Controller. The Rescue Response Procedures are actions utilizing the various vehicle systems that are operatively connected to the Vehicle Accessory Controller (130) to mitigate or to help assist in mitigating the Trigger Event. Once the Central Controller determines the Rescue Response Procedures (535) based on the data collected by the Central Controller and the existence of the various sub-controllers in the Vehicle Accessory Controller, the Central Controller directs the Rescue Response Procedures (540). The Central Controller continues directing the On-Board Rescue Sequence (515), that is, the first and second action, until the Resetting Means is activated (545).

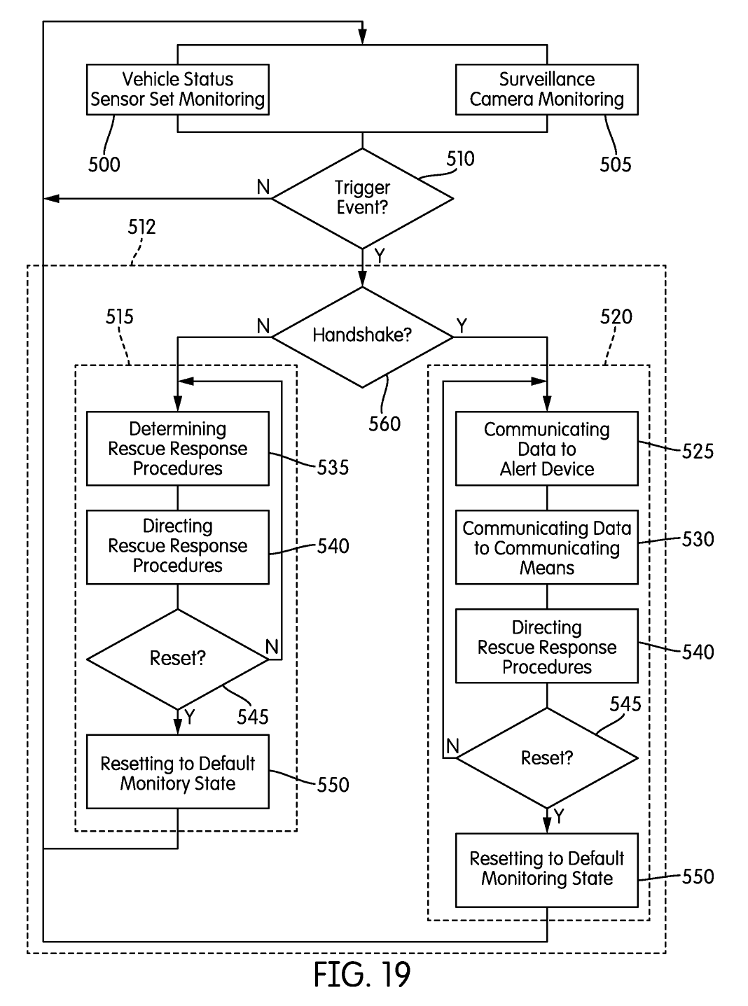

Once the alert responder (106) arrives at the location of the vehicle (101), the alert responder (106) attempts to resolve the Trigger Event and rescue the life form (103). Once the Trigger Event is resolved, and the life form (103) has been rescued, the alert responder (106) may activate the Resetting Means (172). In the event the alert responder activates the Resetting Means (545), the Autonomous Monitoring Device is reset to the Default Monitoring State (550). In the event the alert responder does not activate the Resetting Means (545), the Central Controller continues directing the On-Board Rescue Sequence (515). FIG. 18 shows a flowchart of the autonomous method for detecting and rescuing a life form inside of a vehicle, utilizing the third embodiment (226) of the Autonomous Monitoring Device.

ii) Human Supervised Monitoring Device

A second version of the monitoring device is a Human Supervised Monitoring Device for detecting, verifying and rescuing a life form inside of a vehicle (230) (“Detect, Alert, and On-Board/Remote Rescue”). The Human Supervised Monitoring Device (230) sends out the Alert to the Alert Device (105), allows for an automated on-board rescue response, and allows for a remote rescue response where the alert responder (106) performs the Rescue Response Procedures, if the Trigger Event is detected.

The Human Supervised Monitoring Device (230) comprises the Central Controller (110), the Vehicle Status Sensor Set (120), the Vehicle Accessory Controller (130), the Surveillance Camera (126), the Video Feed (127), the Outbound Alert Data (180), the Inbound Alert Data (182), the Communicating Means (174) and the Resetting Means (172). The Central Controller (110) is operatively connected to the Vehicle Status Sensor Set (120), the Vehicle Accessory Controller (130), the Surveillance Camera (126), the Communicating Means (174), and the Resetting Means (172).

The Inbound Alert Data (182) is received from the Alert Device (105) by the Communicating Means (174) and is communicated to the Central Controller (110). The Inbound Alert Data (182) contains commands for the Central Controller (110) to direct the Vehicle Accessory Controller (130) and its various sub-controllers and to direct the Rescue Response Procedures.

A method for detecting, verifying and rescuing a life form inside of a vehicle, utilizing the Human Supervised Monitoring Device (230) is described below. The Human Supervised Monitoring Device (230) is normally in the Default Monitoring State, gathering data from the inside of the vehicle (101). The Vehicle Status Sensor Set monitors the inside of the vehicle (500). The Vehicle Status Sensor Set (120) communicates data to the Central Controller (110). For example, the Internal Temperature Sensor (122) communicates the Internal Temperature Data (123) to the Central Controller (110). The GPS Locator (124) communicates the GPS Location Data (125) to the Central Controller (110). The Surveillance Camera monitors the inside of the vehicle (505). The Surveillance Camera (176) communicates the Video Feed (127) to the Central Controller (110). The Central Controller (110) evaluates the data communicated to the Central Controller (110). The Vehicle Status Sensor Set (120) and the Surveillance Camera (126) may monitor the inside of the vehicle (101) in a continuous, a periodic, or an event driven manner (e.g. when the Internal Temperature Data has reached a threshold).

In the event the Central Controller detects that the Trigger Event has occurred (510), the Central Controller directs a Life Form Confirmation Sequence (512). The Trigger Event occurs if the Internal Temperature Data (123) has reached a threshold and if the Detecting Means (175) detects the life form (103). In the event the Trigger Event is not detected (510), the Default Monitoring State is maintained.

When the Central Controller directs the Life Form Confirmation Sequence (512), the Central Controller attempts to establish a Handshake Protocol with the Alert Device (560). A Handshake Protocol establishes the existence of a communication link and the basic rules for the manner in which data is to be shared between the Communicating Means (174) and the Alert Device (105).

If the Handshake Protocol is not established within a predetermined amount of time, a Handshake Response Time, the Central Controller (110) assumes that the Alert Device (105) is unavailable and directs the On-Board Rescue Sequence (515). In the On-Board Rescue Sequence (515), the Central Controller (110) is responsible for rescuing the life form (103) from the Trigger Event. The Central Controller determines the Rescue Response Procedures (535) based on the data collected by the Central Controller and the existence of the various sub-controllers in the Vehicle Accessory Controller. Once the Central Controller determines the Rescue Response Procedures (535), the Central Controller directs the Rescue Response Procedures (540). The Central Controller continues directing the On-Board Rescue Sequence (515) until the Resetting Means is activated (545).

In the event the Handshake Protocol is established within the Handshake Response Time, the Central Controller (110) assumes that contact with the Alert Device (105) has been established. The Alert Device (105) is ready to communicate with the Communicating Means (174), and the Central Controller directs a Remote Response Sequence (520). In the Remote Response Sequence (520), the alert responder (106), that is, the user of the Alert Device (105), is responsible for verifying that the life form (103) is indeed in the inside of the vehicle (101) and for determining the Rescue Response Procedures. It is this third party verification that provides greater reliability in minimizing false positive events, that is to say false alarms. For example, a human being examining the data sent from the Communications Means (174) can efficiently and accurately discern if the Life Form (103) is indeed present inside of the vehicle (101). In the first step of the Remote Response Sequence (520), the Central Controller communicates data through the Communicating Means to the Alert Device (525). For example, this data may be one or more of the the Video Feed (127), the Outbound Alert Data (180), or the Historical Video Feed (128). The Alert Device (105) receives this data and the alert responder (106), that is, the user of the Alert Device (105), examines this data and verifies that indeed the Trigger Event exists in the inside of the vehicle (101). If the verification is positive, the alert responder determines the Rescue Response Procedures (537). The Rescue Response Procedures are codified into the Inbound Alert Data (182). The Inbound Alert Data (182) contains commands for the Central Controller (110) to direct Rescue Response Procedures by directing the Vehicle Accessory Controller (130) and its various sub-controllers. The Inbound Alert Data (182) is communicated through the Alert Device (105). The Communicating Means receives the Inbound Alert Data (530). The Central Controller directs the Rescue Response Procedures (540) based on the Inbound Alert Data. The alert responder (106) may also initiate rescue efforts such as sending other alert responders (106) to the location of the vehicle (101) to rescue the life form (103). The Central Controller continues to direct the Remote Rescue Sequence (520) until the Resetting Means is activated (545). FIG. 5 is a schematic drawing of the flow of data to and from Communicating Means (174) and the Alert Device (105). The Communicating Means (174) communicates the Video Feed (127) and the Outbound Alert Data (180) to the Alert Device (105). The Outbound Alert Data (180) is comprised the Internal Temperature Data (123) and the GPS Location Data (125). Data communicated to the Communicating Means (174) from the Alert Device (105) may include the Inbound Alert Data (182).

The method for detecting, verifying and rescuing a life form inside of a vehicle, utilizing the Human Supervised Monitoring Device (230) provides system redundancy since it has two paths to mitigate the Trigger Event, that is the On-Board Rescue Sequence (515) and the Remote Response Sequence (520). In the event that the Remote Response Sequence (520) is not available, the On-Board Rescue Sequence (515) is used to mitigate the Trigger Event. Because the Central Controller (110) has the capability to determine the Rescue Response Procedures and direct the Rescue Response Procedures, the method for detecting, verifying and rescuing a life form inside of a vehicle, utilizing the Human Supervised Monitoring Device (230) provides for a fail-sate alternative if the Remote Response Sequence (520) is not available. Because the Handshake Response Time limits the time to establish the Handshake Protocol with the Alert Device (105), the Central Controller (110) quickly goes into its fail-safe mode, that is the On-Board Rescue Sequence (515) and does not further waste time trying to establish the Handshake Protocol with the Alert Device (105). Even if the Central Controller directs the On-Board Rescue Sequence (515), the Central Controller may have the capability to continue attempting to establish the Handshake Protocol.

Once the alert responder (106) arrives at the location of the vehicle (101), an attempt to rescue the life form (103) is initiated. Once the Trigger Event is resolved and the life form (103) has been rescued, the alert responder (106) may activate the Resetting Means (172) within the vehicle (101). In the event the alert responder activates the Resetting Means (545), the Human Supervised Monitoring Device (230) is reset to the Default Monitoring State (550). If the alert responder does not activate the Resetting Means (545), the Central Controller continues to direct either the On-Board Rescue Sequence (515) or the Remote Response Sequence (520). The Resetting Means (172) may be activated remotely by the Inbound Alert Data (182). FIG. 19 shows a flowchart of the method for detecting, verifying and rescuing a life form inside of a vehicle, utilizing the Human Supervised Monitoring Device (230).

(2) Distress Event Monitoring Device for Rescuing a Life Form Inside of a Vehicle

The second instance of the invention is a Distress Event Monitoring Device for rescuing a life form inside of a vehicle (240). The Distress Event Monitoring Device (240) detects the Trigger Event inside of the vehicle (101) and attempts to rescue the life form (103). The Trigger Events, for example, may be a car-jacking, an accident, or a robbery. The Distress Event Monitoring Device (240) is a generalized solution to mitigate the Trigger Events.

A first embodiment (242) of the Distress Event Monitoring Device sends a Distress Alert to the Alert Device (105), if the Trigger Event is detected (“Distress Trigger and Alert”). The first embodiment (242) of the Distress Event Monitoring Device is comprised of the Central Controller (110), the Vehicle Status Sensor Set (120), the Surveillance Camera (126), the Video Feed (127), Outbound Distress Data (184), the Communicating Means (174), the Resetting Means (172) and an Indicating Means (170). The Central Controller (110) is operatively connected to the Vehicle Status Sensor Set (120), the Surveillance Camera (126), the Communicating Means (174), the Resetting Means (172), and the Indicating Means (170).

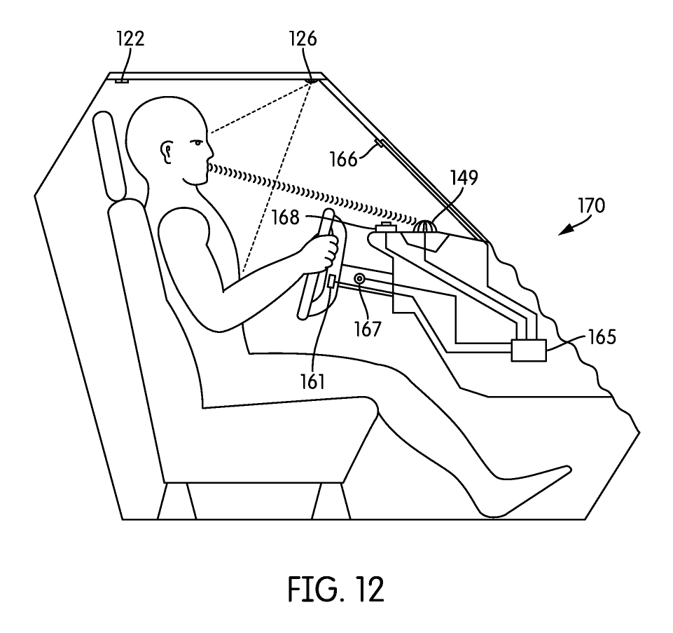

The Indicating Means (170) detects situations that may necessitate the Rescue Response Procedures to be performed. The Indicating Means (170) is comprised of a Distress Controller (165) and a Distress Sensor (169). The Distress Controller (165) is operatively connected to the Central Controller (110). The Distress Controller (165) is operatively connected to one or more Distress Sensors (169), such as a Window Breaking Sensor (166), an Ignition Tampering Sensor (167), an Airbag Deployment Sensor (161), a Distress Button (168), and a Voice Activated Distress Sensor (149). The Distress Sensor (169) detects an event associated with a distress situation. The activation of the Window Breaking Sensor (166) may mean that the vehicle is going through a car-jacking, an accident, or a theft. The activation of the Ignition Tampering Sensor (167) may mean that the vehicle is being stolen. The activation of the Airbag Deployment Sensor (161) may indicate that the vehicle (101) is involved in a car accident. The activation of the Distress Button (168) may mean that the life form (103) inside of the vehicle (101) is going through a car-jacking, an accident or a theft. The vehicle driver or passenger may press the Distress Button (168) in a distress situation such as a car crash, carjacking, or medical emergency. The Voice Activated Distress Sensor (149) may be activated by a specific voice command or sound pattern. The Voice Activated Distress Sensor (149) is suitable in scenarios where the life form (103) is incapacitated and not able to activate the Distress Button (168). In the event the Distress Sensor (169) is activated, the Distress Sensor (169) sends a signal to the Distress Controller (165). When the Distress Controller (165) receives the signal from one or more of the various Distress Sensors (169), the Distress Controller (165) sends a signal to the Central Controller (110) indicating that the Indicating Means (170) has been activated. FIG. 12 shows the Indicating Means (170). It is an inside view of the front part of the vehicle (101) with the life form (103) occupying the inside of the vehicle (101). The Indicating Means (170) is located inside of the vehicle (101). The Distress Controller (165) is operatively connected to the Voice Activated Distress Sensor (149), the Window Breaking Sensor (166), the Ignition Tampering Sensor (167), the Airbag Deployment Sensor (161), and the Distress Button (168). Two Surveillance Cameras (126) monitor the inside of the vehicle (101).

The Outbound Distress Data (184) comprises data that signals the Trigger Event has occurred and/or that describes the Trigger Event. The Outbound Distress Data (184) may range from a simple indication that a Trigger Event has occurred to data gathered from the Central Controller (110) and the Vehicle Status Sensor Set (120). The Outbound Distress Data (184) may contain data necessary to describe the Trigger Event detected inside of the vehicle (101). For example, the Outbound Distress Data (184) may comprise any of the following: the GPS Location Data (125), the Internal Temperature Data (123), the Event Time Data (119), or the Vehicle Description Data (188). The Central Controller (110) outputs the Outbound Distress Data (184) and communicates the Outbound Distress Data (184) to the Communicating Means (174).

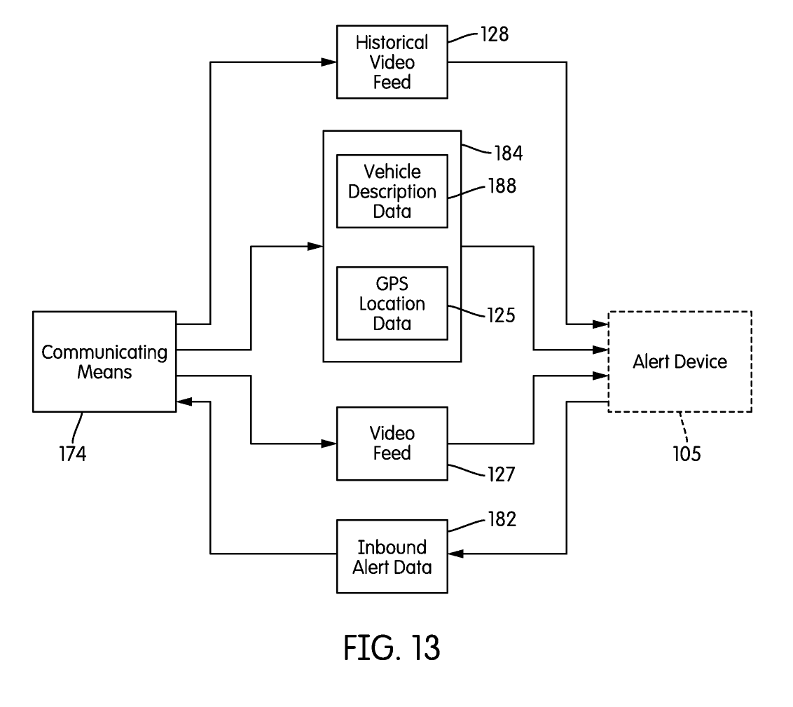

FIG. 13 is a schematic drawing of the flow of data to and from the Communicating Means (174) and the Alert Device (105). The flow of data includes the Video Feed (127), the Historical Video Feed (128), the Outbound Distress Data (184), and the Inbound Alert Data (182). The Outbound Distress Data (184) comprises the Vehicle Description Data (188) and the GPS Location Data (125). The Communicating Means (174) transmits the Video Feed (127), the Historical Video Feed (128), and the Outbound Distress Data (184) to the Alert Device (105). The Communicating Means receives the Inbound Alert Data (182) from the Alert Device (105).

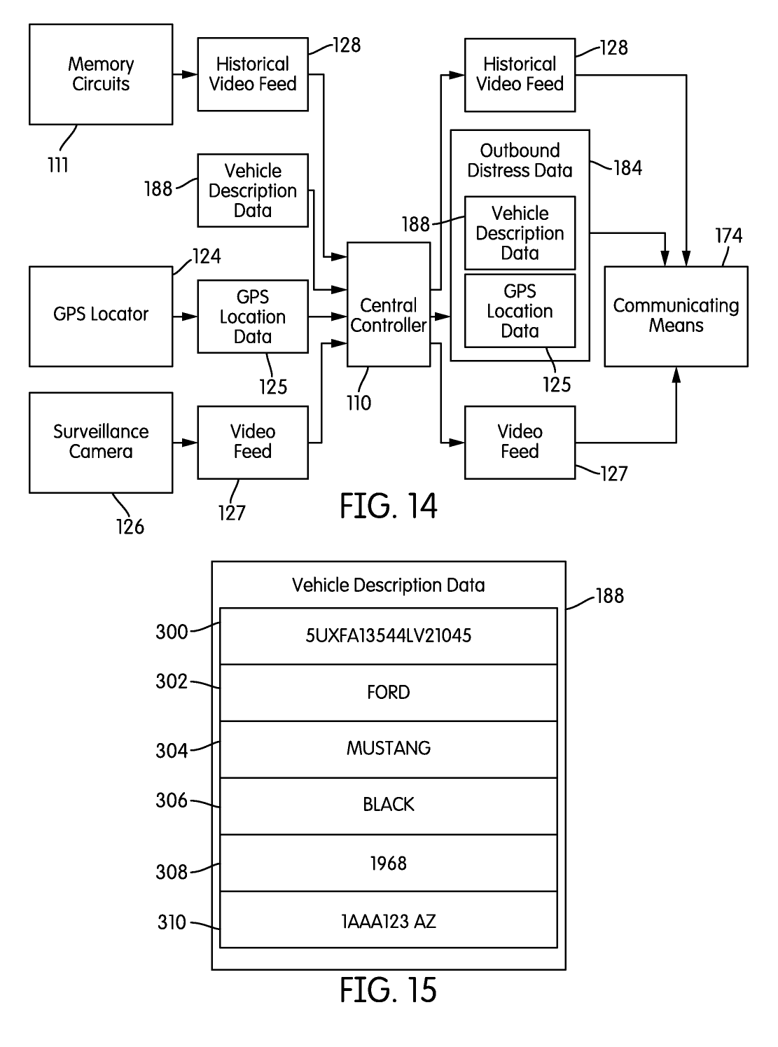

FIG. 14 is a schematic drawing of the flow of data through the Central Controller (110) to the Communicating Means (174). The flow of data from the Central Controller (110) to the Communicating Means (174) includes the Video Feed (127), the Historical Video Feed (128), the Outbound Distress Data (184), and the Inbound Alert Data (182). The Outbound Distress Data (184) comprises the Vehicle Description Data (188) and the GPS Location Data (125). The Surveillance Camera (126) outputs and communicates the Video Feed (127) to the Central Controller (110). The GPS Locator (124) outputs and communicates the GPS Location Data (125) to the Central Controller (110). The Memory Circuits (111) outputs and communicate the Historical Video Feed (128) to the Central Controller (110). The Central Controller (110) outputs and communicates the Outbound Distress Data (184) to the Communicating Means (174).

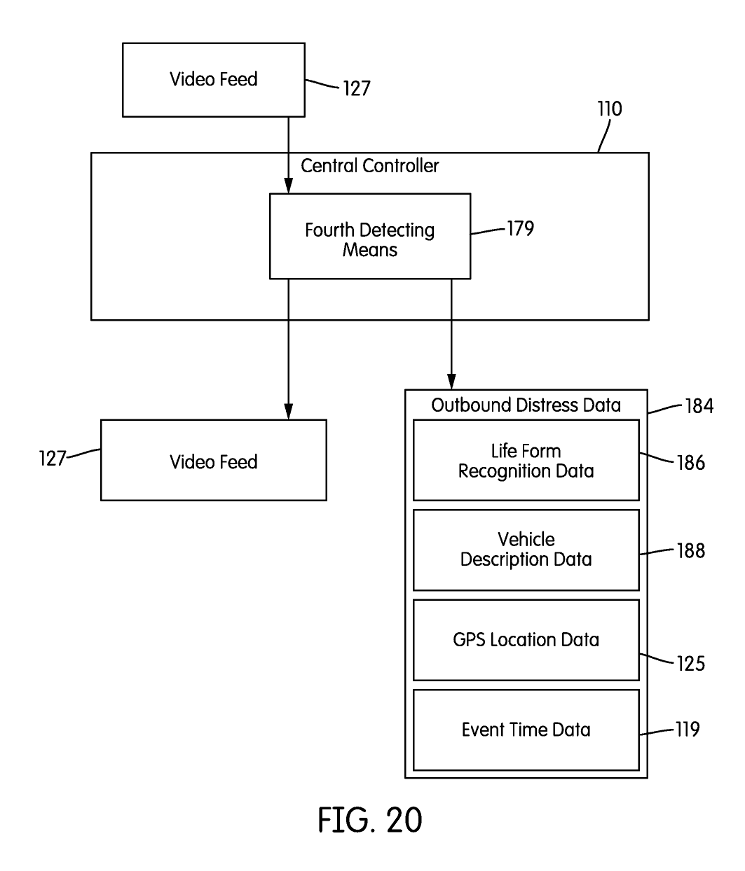

The Outbound Distress Data (184) may also comprise Life Form Recognition Data (186). The Life Form Recognition Data (186) describes the life forms (103) that have been detected and recognized inside of the vehicle (101) by the Detecting Means (174). For instance, the Fourth Detecting Means (179) has the capability of detecting the life form (103), detecting the face of the life form (103), and recognizing the face of the life form (103). The Fourth Detecting Means (179) analyzes the Video Feed (127) and utilizes the Shape Detection Algorithm (112) and the Face Detection Algorithm (116) to detect the life form (103). Once the life form (103) is detected, the Fourth Detecting Means (179) utilizes the Face Recognition Algorithm (115) to recognize the life form (103). Data identifying recognized life forms may be located within the vehicle (101), the Distress Event Monitoring Device (240), the Central Controller (110), the Memory Circuits (111), or an off-vehicle data location. The Distress Event Monitoring Device (240) may retrieve data stored in an off-vehicle data location through the Communicating Means (174) as the Inbound Alert Data (182). By utilizing the Life Form Recognition Data (186), the alert responders (106) may better understand the nature of the Trigger Event. For example, the Life Form Recognition Data (186) may discern the owner of the vehicle and the owner's family (recognized life forms) from car-jackers (non-recognized life form). The Life Form Recognition Data (186) may be able to discern the owner of the vehicle from a car thief. FIG. 20 is a flow diagram of the Video Feed (127) being analyzed by the Fourth Detecting Means (179) within the Central Controller (110). The Fourth Detecting Means (179) and the Central Controller (110) outputs the Outbound Distress Data (184). The Outbound Distress Data (184) comprises the Life Form Recognition Data (186), the Vehicle Description Data (188), the GPS Location Data (125) and the Event Time Data (119). The Life Form Recognition Data (186) contains data discerning recognized and non-recognized life forms inside of the vehicle (101).

A method for rescuing a life form utilizing the first embodiment (242) of the Distress Event Monitoring Device is described below. The first embodiment (242) of the Distress Event Monitoring Device is normally in the Default Monitoring State, gathering data from inside of the vehicle (101). The Vehicle Status Sensor Set (120) monitors the inside of the vehicle (500). The Vehicle Status Sensor Set (120) communicates data to the Central Controller (110). For example, the GPS Locator (124) communicates the GPS Location Data (125) to the Central Controller (110). The Surveillance Camera monitors the inside of the vehicle (505). The Surveillance Camera (126) communicates the Video Feed (127) to the Central Controller (110). The Central Controller (110) evaluates the data communicated to the Central Controller (110). The Vehicle Status Sensor Set (120) and the Surveillance Camera (126) may monitor the inside of the vehicle (101) in a continuous, a periodic, or an event driven manner (e.g. when the Indicating Means (170) is activated).

In the event the Central Controller detects that the Trigger Event has occurred (510), the Central Controller directs the On-Board Rescue Sequence (515). In the event, the Trigger Event is not detected (510), the Default Monitoring State is maintained. In the first embodiment (242) of the Distress Event Monitoring Device, the Trigger Event occurs when the Indicating Means (170) is activated. In the On-Board Rescue Sequence (515), the Central Controller communicates data through the Communicating Means to the Alert Device (525). For example, the data may be at least one of the Video Feed (127), the Outbound Distress Data (184), or the Historical Video Feed (128). The Alert Device (105) receives this data and the alert responder (106), that is, the user of the Alert Device (105), examines this data. The alert responder (106) initiates rescue efforts such as sending other alert responders (106) to the location of the vehicle (101) to rescue the life form (103). The Central Controller (110) continues to direct the On-Board Rescue Sequence (515) until the Resetting Means is activated (545).

Once the alert responder (106) arrives at the location of the vehicle (101), an attempt to rescue the life form (103) is initiated. Once the Trigger Event is resolved and the life form (103) has been rescued, the alert responder (106) may activate the Resetting Means (172) within the vehicle (101). In the event the alert responder activates the Resetting Means (545), the Distress Event Monitoring Device is reset to the Default Monitoring State (550). In the event the alert responder does not activate the Resetting Means (545), the Central Controller continues directing the On-Board Rescue Sequence (515).

A second embodiment (244) of the Distress Event Monitoring Device sends the Distress Alert to the Alert Device (105) and allows for an automated on-board rescue response, if the Trigger Event is detected. (“Distress Trigger, Alert and On-Board Rescue”). The second embodiment (244) of the Distress Event Monitoring Device comprises the first embodiment (242) of the Distress Event Monitoring Device and the Vehicle Accessory Controller (130). The Vehicle Accessory Controller (130) is operatively connected to the Central Controller (110).

A method for rescuing a life form, utilizing the second embodiment (244) of the Distress Event Monitoring Device is described below. The second embodiment (244) of the Distress Event Monitoring Device is normally in the Default Monitoring State, gathering data from inside of the vehicle (101). The Vehicle Status Sensor Set (120) and the Indicating Means (170) provide data to the Central Controller (110). The Surveillance Camera (126) monitors the inside of the vehicle (101). The Vehicle Status Sensor Set monitors the inside of the vehicle (500). The Vehicle Status Sensor Set (120) outputs and communicates data to the Central Controller (110). For example, the GPS Locator (124) outputs and communicates the GPS Location Data (125) to the Central Controller (110). The Surveillance Camera monitors the inside of the vehicle (505). The Surveillance Camera (126) outputs and communicates the Video Feed (127) to the Central Controller (110). The Central Controller (110) evaluates the data communicated to the Central Controller. The Vehicle Status Sensor Set (120) and the Surveillance Camera (126) may monitor the inside of the vehicle (101) in a continuous, a periodic, or an event driven manner (e.g. when the Indicating Means (170) is activated).

If the Central Controller detects that the Trigger Event has occurred (510), the Central Controller directs the On-Board Rescue Sequence (515). In the second embodiment (244) of the Distress Event Monitoring Device, the Trigger Event occurs when the Indicating Means (170) is activated. In the event the Trigger Event is not detected (510), the Default Monitoring State is maintained.

When the Central Controller directs the On-Board Rescue Sequence (515), the Central Controller (110) performs two simultaneous actions. In the first action, the Central Controller communicates data through the Communicating Means to the Alert Device (525). This data may be at least one of the Video Feed (127), the Outbound Distress Data (184), or the Historical Video Feed (128). The Alert Device (105) receives this data and the alert responder (106), that is, the user of the Alert Device (105), examines this data. The alert responder (106) viewing the Alert Device (105) is informed of the Trigger Event as described by the data that the Alert Device (105) receives. The alert responder (106) initiates rescue efforts such as sending alert responders (106) to the location of the vehicle (101) to rescue the life form (103).

In the second action, the Central Controller determines the Rescue Response Procedures (535) based on the data collected by the Central Controller and the existence of the various sub-controllers in the Vehicle Accessory Controller. The Rescue Response Procedures are actions utilizing the various vehicle systems that are regulated by the Central Controller (110), the Vehicle Accessory Controller (130) and the Vehicle Accessory Sub-Controllers to mitigate or help assist mitigating the Trigger Event. Once the Central Controller determines the Rescue Response Procedures (535) based on the data collected by the Central Controller and the utilization of the various sub-controllers in the Vehicle Accessory Controller, the Central Controller directs the Rescue Response Procedures (540). The Central Controller continues directing the On-Board Rescue Sequence (515) until the Resetting Means is activated (545).

Once the alert responder (106) arrives at the location of the vehicle (101), an attempt to rescue the life form (103) is initiated. Once the Trigger Event is resolved, and the life form (103) has been rescued, the alert responder (106) may activate the Resetting Means (172) within the vehicle (101). In the event the alert responder activates the Resetting Means (545), the Distress Event Monitoring Device is reset to the Default Monitoring State (550). In the event the alert responder does not activate the Resetting Means (545), the Central Controller continues to direct the On-Board Rescue Sequence (515). FIG. 18 shows a flowchart of the method for rescuing a life form, utilizing the second embodiment (244) of the Distress Event Monitoring Device.

A third embodiment (246) of the Distress Event Device sends out the Distress Alert to the Alert Device (105), allows for an automated on-board rescue response, and allows for a remote rescue response where the alert responder (106) performs the Rescue Response Procedures, if the Trigger Event is detected (“Distress Trigger, Alert, and On-Board/Remote Rescue”). The third embodiment (246) of the Distress Event Monitoring Device comprises the second embodiment (244) of the Distress Event Monitoring Device and the Inbound Alert Data (182).

A method for detecting, verifying, and rescuing a life form inside of a vehicle, utilizing the third embodiment (246) of the Distress Event Device is described below. The third embodiment (246) of the Distress Event Monitoring Device is normally in the Default Monitoring State, gathering data from inside of the vehicle (101). The Vehicle Status Sensor Set monitors the inside of the vehicle (500). The Vehicle Status Sensor Set (120) communicates data to the Central Controller (110). For example, the Internal Temperature Sensor (122) communicates the Internal Temperature Data (123) to the Central Controller (110). The GPS Locator (124) communicates the GPS Location Data (125) to the Central Controller (110). The Surveillance Camera monitors the inside of the vehicle (505). The Surveillance Camera (123) communicates the Video Feed (127) to the Central Controller (110). The Central Controller (110) evaluates the data communicated to the Central Controller. The Vehicle Status Sensor Set (120) and the Surveillance Camera (126) may monitor the inside of the vehicle (101) in a continuous, a periodic, or an event driven manner (e.g. when the Indicating Means (170) is activated),

In the event the Central Controller detects that the Trigger Event has occurred (510), the Central Controller directs the Life Form Confirmation Sequence (512). The Trigger Event occurs if the Indicating Means (170) is activated. In the event the Trigger Event is not detected (510), the Default Monitoring State is maintained.

When the Central Controller directs the Life Form Confirmation Sequence (512), the Central Controller attempts to establish a Handshake Protocol with the Alert Device (560). A Handshake Protocol establishes the existence of a communication link and the basic rules for the way data is to be shared between the Communicating Means (174) and the Alert Device (105).

If the Handshake Protocol is not established within a predetermined amount of time, a Handshake Response Time, the Central Controller (110) assumes that the Alert Device (105) is unavailable and directs the On-Board Rescue Sequence (515). In the On-Board Rescue Sequence (515), the Central Controller (110) is responsible for rescuing the life form (103) from the Trigger Event. The Central Controller determines the Rescue Response Procedures (535) based on the data collected by the Central Controller and the existence of the various sub-controllers in the Vehicle Accessory Controller. Once the Central Controller determines the Rescue Response Procedures (535), the Central Controller directs the Rescue Response Procedures (540). The Central Controller continues directing the On-Board Rescue Sequence (515) until the Resetting Means is activated (545).

In the event the Handshake Protocol is established within the Handshake Response Time (560), the Central Controller (110) assumes that contact with the Alert Device (105) has been established. The Alert Device (105) is ready to communicate with the Communicating Means (174), and the Central Controller directs the Remote Response Sequence (520). In the Remote Response Sequence (520), the alert responder (106), that is, the user of the Alert Device (105), is responsible for verifying that the life form (103) is indeed in the inside of the vehicle (101) and for determining the Rescue Response Procedures. It is this third party verification that provides greater reliability in minimizing false positive events, that is to say false alarms. For example, a human being examining the data sent from the Communications Means (174) can efficiently and accurately discern if the Life Form (103) is indeed present inside of the vehicle (101). In the first step of Remote Response Sequence (520), the Central Controller communicates data through the Communicating Means to the Alert Device (525). This data may be one or more of the Video Feed (127), the Outbound Distress Data (184), or the Historical Video Feed (128). The Alert Device (105) receives the data and the alert responder (106), that is, the user of the Alert Device (105), examines this data and verifies that indeed there is a Trigger Event in the inside of the vehicle (101). If the verification is positive, the alert responder determines Rescue Response Procedures (537). The Rescue Response Procedures are codified into the Inbound Alert Data (182). The Inbound Alert Data (182) contains commands for the Central Controller (110) to direct the Rescue Response Procedures (540) by directing the Vehicle Accessory Controller (130) and its various sub-controllers. The Inbound Alert Data (182) is received from the Alert Device (105) by the Communicating Means (174) and is communicated to the Central Controller (110). The Central Controller directs the Rescue Response Procedures (540) based on the Inbound Alert Data (182). The alert responder (106) may also initiate rescue efforts such as sending other alert responders (106) to the location of the vehicle (101) to rescue the life form (103). The Central Controller continues to direct the Remote Rescue Sequence (520) until the Resetting Means is activated (545). FIG. 13 is a schematic drawing of the flow of data to and from the Communicating Means (174) and the Alert Device (105). The flow of data includes the Video Feed (127), the Historical Video Feed (128), the Outbound Distress Data (184) and the Inbound Alert Data (182). The Outbound Distress Data (184) comprises the Vehicle Description Data (188) and the GPS Location Data (125).

Once the alert responder (106) arrives at the location of the vehicle (101), an attempt to rescue the life form (103) is initiated. Once the Trigger Event is resolved, and the life form (103) has been rescued, the alert responder (106) may activate the Resetting Means (172) within the vehicle (101). In the event the alert responder activates the Resetting Means (545), the Distress Event Monitoring Device is reset to the Default Monitoring State (550). In the event the alert responder does not activate the Resetting Means (545), the Central Controller continues to direct the Remote Response Sequence (520). The Resetting Means (172) may be activated remotely by the Inbound Alert Data (182).

While the foregoing written description of the invention enables a person having ordinary skill in the art to make and use what is considered presently to be the best mode thereof, those of ordinary skill in the art will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### SEQUENCE LISTING

Not Applicable

I claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A Human Supervised Monitoring Device for detecting, verifying, and rescuing a life form inside of a vehicle, the Human Supervised Monitoring Device comprising:
a.) A Central Controller, comprising:
i.) Means for Detecting a Life Form;
ii.) Event Time Data; and
iii.) An On-Board Clock, where the On-Board Clock outputs the Event Time Data,
b.) A Vehicle Status Sensor Set, comprising:
i.) An Internal Temperature Sensor, where the Internal Temperature Sensor is operatively connected to the Central Controller;
ii.) Internal Temperature Data, where the Internal Temperature Sensor outputs the Internal Temperature Data, where the Internal Temperature Sensor communicates the Internal Temperature Data to the Central Controller;
iii.) A GPS Locator, where the GPS Locator is operatively connected to the Central Controller; and
iv.) GPS Location Data, where the GPS Locator outputs the GPS Location Data, where the GPS Locator communicates the GPS Location Data to the Central Controller;
c.) A Vehicle Accessory Controller, comprising:
i.) An Air Conditioning Sub-Controller, where the Central Controller directs the Air Conditioning Sub-Controller; and
ii.) An Engine Sub-Controller, where the Central Controller directs the Engine Sub-Controller,
iii.) Where the Vehicle Accessory Controller is operatively connected to the Central Controller;
d.) A Surveillance Camera, where the Surveillance Camera is operatively connected to the Central Controller;
e.) A Video Feed, where the Surveillance Camera communicates the Video Feed to the Central Controller;
f.) Outbound Alert Data, comprising:
i.) The GPS Location Data;
ii.) The Internal Temperature Data; and
iii.) The Event Time Data,
iv.) Where the Central Controller outputs the Outbound Alert Data;
g.) Inbound Alert Data;
h.) Means for Communicating Data to be detected by and from an alert device,
i.) Where the Central Controller is operatively connected to the Communicating Means,
ii.) Where the Central Controller communicates the Outbound Alert Data and the Video Feed to the Communicating Means,
iii.) Where the Communicating Means transmits the Video Feed and the Outbound Alert Data to the alert device,
iv.) Where the Communicating Means receives the Inbound Alert Data from the alert device,
v.) Where the Communicating Means communicates the Inbound Alert Data to the Central Controller; and
i.) Means for Resetting Rescue Sequence,
i.) Where the Central Controller is operatively connected to the Resetting Means.

15. The Human Supervised Monitoring Device according to claim 14,
a.) Wherein the Central Controller further comprises Memory Circuits, where the Memory Circuits stores Video Feed.

16. The Human Supervised Monitoring Device according to claim 14,
a.) Wherein the Vehicle Accessory Controller further comprises at least one of a Windows Sub-Controller, a Light Sub-Controller, a Sound Sub-Controller, a Horn Sub-Controller, a Lock Sub-Controller, or a Heating Controller,
b.) Where the Central Controller directs the Windows Sub-Controller, the Light Sub-Controller, the Sound Sub-Controller, the Horn Sub-Controller, the Lock Sub-Controller, and the Heating Controller.

17. A Human Supervised Method for detecting, verifying and rescuing a life form

14. f a vehicle, using the Human Supervised Monitoring Device in claim 14, the Human Supervised Method comprising the steps of:
a.) Having the Vehicle Status Sensor Set monitor the inside of the vehicle;
b.) Having the Internal Temperature Sensor communicate the Internal Temperature Data to the Central Controller;
c.) Having the GPS Locator communicate the GPS Location Data to the Central Controller;
d.) Having the Surveillance Camera monitor the inside of the vehicle;
e.) Having the Surveillance Camera communicate the Video Feed to the Central Controller;
f.) Having the Central Controller evaluate the Internal Temperature Data and the GPS Location Data;
g.) Having the Detecting Means Evaluate the Video Feed; and
h.) Entering a Life Form Confirmation Sequence when the Central Controller determines that the Internal Temperature Data has reached a threshold and the Detecting Means detects the life form, where the Life Form Confirmation Sequence comprises the steps of:
i.) Attempting to establish a handshake protocol with the alert device;
ii.) Entering a Remote Rescue Sequence if the handshake protocol with the alert device is established within a Monitoring Handshake Response Time, where the Remote Rescue Sequence comprises the steps of:
A.) Transmitting the Outbound Alert Data through the Communicating Means;
B.) Transmitting the Video Feed through the Communicating Means;
C.) Receiving the Inbound Alert Data through the Communicating Means;
D.) Having the Central Controller direct the Engine Sub-Controller based on the Inbound Alert Data;
E.) Having the Central Controller direct the Air Conditioning Sub-Controller based on the Inbound Alert Data; and
F.) Having the Central Controller reset the Human Supervised Monitoring Device if the Resetting Means is activated; and
iii.) Entering an On-Board Rescue Sequence if the handshake protocol with the alert device is not established within the Handshake Response Time, where the On-Board Rescue Sequence comprises the steps of:
A.) Having the Central Controller determine Rescue Response Procedures;
B.) Having the Central Controller direct the Engine Sub-Controller;
C.) Having the Central Controller direct the Air Conditioning Sub-Controller; and
D.) Having the Central Controller reset the Human Supervised Monitoring Device when the Resetting Means is activated.

18. An Improved Human Supervised Method for detecting, verifying and rescuing a life form inside of a vehicle, using the Human Supervised Monitoring Device in claim 15, the Improved Human Supervised Method comprising the steps of:
a.) Having the Vehicle Status Sensor Set monitor the inside of the vehicle;
b.) Having the Internal Temperature Sensor communicate the Internal Temperature Data to the Central Controller;
c.) Having the GPS Locator communicate the GPS Location Data to the Central Controller;
d.) Having the Surveillance Camera monitor the inside of the vehicle;
e.) Having the Surveillance Camera communicate the Video Feed to the Central Controller;
f.) Having the Central Controller evaluate the Internal Temperature Data;
g.) Having the Detecting Means evaluate the Video Feed; and
h.) Entering a Life Form Confirmation Sequence when the Central Controller determines that the Internal Temperature Data has reached a threshold and the Detecting Means detects the life form, where the Life Form Confirmation Sequence comprises the steps of:
i.) Attempting to establish a handshake protocol with the alert device;
ii.) Having the Central Controller store Video Feed in the Memory Circuits;
iii.) Entering a Remote Rescue Sequence if the handshake protocol with the alert device is established within a Monitoring Handshake Response Time, where the Remote Rescue Sequence comprises the steps of:
A.) Transmitting the Outbound Alert Data through the Communicating Means;
B.) Transmitting the Video Feed stored in the Memory Circuits through the Communicating Means;
C.) Transmitting the Video Feed through the Communicating Means;
D.) Receiving the Inbound Alert Data through the Communicating Means;
E.) Having the Central Controller direct the Engine Sub-Controller based on the Inbound Alert Data;
F.) Having the Central Controller direct the Air Conditioning Sub-Controller based on the Inbound Alert Data; and
G.) Having the Central Controller reset the Human Supervised Monitoring Device if the Resetting Means is activated; and
iv.) Entering an On-Board Rescue Sequence if the handshake protocol with the alert device is not established within the Handshake Response Time, where the On-Board Rescue Sequence comprises the steps of:
A.) Having the Central Controller determine Rescue Response Procedures;
B.) Having the Central Controller direct the Engine Sub-Controller;
C.) Having the Central Controller direct the Air Conditioning Sub-Controller; and
D.) Having the Central Controller reset the Human Supervised Monitoring Device when the Resetting Means is activated.

19. A Distress Event Monitoring Device for rescuing a life form inside of a vehicle, the Distress Event Monitoring Device comprising:
a.) A Central Controller, comprising:
i.) Means for Detecting a Life Form; and
ii.) Vehicle Description Data;
b.) A Vehicle Status Sensor Set, comprising:
i.) A GPS Locator, where the GPS Locator is operatively connected to the Central Controller; and
ii.) GPS Location Data, where the GPS Locator outputs the GPS Location Data, where the GPS Locator communicates the GPS Location Data to the Central Controller;
c.) A Surveillance Camera, where the Surveillance Camera is operatively connected to the Central Controller;
d.) A Video Feed, where the Surveillance Camera communicates the Video Feed to the Central Controller;
e.) Outbound Distress Data, the Outbound Distress Data comprising:
i.) The GPS Location Data; and
ii.) The Vehicle Description Data;
iii.) Where the Central Controller outputs the Outbound Distress Data;
f.) Means for Communicating Data to be detected by and from an alert device,
i.) Where the Central Controller is operatively connected to the Communicating Means,
ii.) Where the Central Controller communicates the Outbound Distress Data and the Video Feed to the Communicating Means,
iii.) Where the Communicating Means transmits the Video Feed and the Outbound Distress Data to the alert device;
g.) Means for Indicating a Distress Event; where the Indicating Means is operatively connected to the Central Controller; and
h.) Means for Resetting Rescue Sequence,
i.) Where the Central Controller is operatively connected to the Resetting Means.

20. (canceled)

21. The Distress Event Monitoring Device according to claim 19, the Distress Event Monitoring Device further comprising:
a.) A Vehicle Accessory Controller,
b.) Where the Vehicle Accessory Controller is operatively connected to the Central Controller.

22. The Distress Event Monitoring Device according to claim 21, the Distress Event Monitoring Device further comprising:
a.) Wherein the Vehicle Accessory Controller comprises an Engine Sub-Controller,
b.) Where the Central Controller directs the Engine Sub-Controller.

23. The Distress Event Monitoring Device according to claim 22,
a.) Wherein the Vehicle Accessory Controller further comprises at least one of a Windows Sub-Controller, a Light Sub-Controller, a Sound Sub-Controller, a Horn Sub-Controller, a Lock Sub-Controller, an Air Conditioning Sub-Controller, or a Heating Controller,
b.) Where the Central Controller directs the Windows Sub-Controller, the Light Sub-Controller, the Sound Sub-Controller, the Horn Sub-Controller, the Lock Sub-Controller, and the Heating Controller.

24. The Distress Event Monitoring Device according to claim 21, the Distress Event Monitoring Device further comprising:
a.) Inbound Alert Data,
b.) Where the Communicating Means receives the Inbound Alert Data from the alert device,
c.) Where the Communicating Means communicates the Inbound Alert Data to the Central Controller.

25. The Distress Event Monitoring Device according to claim 24,
a.) Wherein the Vehicle Accessory Controller comprises an Engine Sub-Controller,
b.) Where the Central Controller directs the Engine Sub-Controller.

26. The Distress Event Monitoring Device according to claim 25,
a.) Wherein the Vehicle Accessory Controller further comprises at least one of a Windows Sub-Controller, a Light Sub-Controller, a Sound Sub-Controller, a Horn Sub-Controller, a Lock Sub-Controller, an Air Conditioning Sub-Controller, or a Heating Controller,
b.) Where the Central Controller directs the Windows Sub-Controller, the Light Sub-Controller, the Sound Sub-Controller, the Horn Sub-Controller, the Lock Sub-Controller, and the Heating Controller.

27. The Distress Event Monitoring Device according to claim 25,
a.) Wherein the Central Controller further comprises Memory Circuits, where the Memory Circuits stores Video Feed.

28. The Distress Event Monitoring Device according to claim 25,
a.) Wherein the Central Controller further comprises Memory Circuits, where the Memory Circuits stores Video Feed.

29. A Distress Event Monitoring Method for rescuing a life form inside of a vehicle, using the Distress Event Monitoring Device in claim 25, the Distress Event Monitoring Method comprising the steps of:
a.) Having the Surveillance Camera monitor the inside of the vehicle;
b.) Having the Vehicle Status Sensor Set monitor the inside of the vehicle;
c.) Having the Surveillance Camera communicate the Video Feed to the Central Controller;
d.) Having the GPS Locator communicate the GPS Location Data to the Central Controller; and
e.) Entering a Car Distress Sequence when the Indicating Means is activated, where the Car Distress Sequence comprising the steps of:
i.) Attempting to establish a handshake protocol with the alert device;
ii.) Entering a Remote Distress Sequence if the handshake protocol with the alert device is established within a Monitoring Handshake Response Time, where the Remote Distress Sequence comprises the steps of:
A.) Transmitting the Outbound Distress Data through the Communicating Means;
B.) Transmitting the Video Feed through the Communicating Means;
C.) Receiving the Inbound Alert Data through the Communicating Means;
D.) Having the Central Controller direct the Engine Sub-Controller based on the Inbound Alert Data; and
E.) Having the Central Controller reset the Distress Event Monitoring Device if the Resetting Means is activated;
iii.) Entering an On-Board Distress Sequence if the handshake protocol with the alert device is not established within the Monitoring Handshake Response Time, where the On-Board Distress Sequence comprises the steps of:
A.) Having the Central Controller determine Rescue Response Procedures;
B.) Having the Central Controller direct the Engine Sub-Controller; and
C.) Having the Central Controller reset the Distress Event Monitoring Device if the Resetting Means is activated.

30. An Improved Distress Event Monitoring Method for rescuing a life form inside of a vehicle, using the Distress Event Monitoring Device in claim 27, the Improved Distress Event Monitoring Method comprising the steps of:
a.) Having the Surveillance Camera monitor the inside of the vehicle;
b.) Having the Vehicle Status Sensor Set monitor the inside of the vehicle;
c.) Having the Surveillance Camera communicate the Video Feed to the Central Controller;
d.) Having the GPS Locator communicate the GPS Location Data to the Central Controller; and
e.) Entering a Car Distress Sequence when the Indicating Means is activated, where the Car Distress Sequence comprises the steps of:
i.) Having the Central Controller store Video Feed in the Memory Circuits;
ii.) Attempting to establish a handshake protocol with the alert device;
iii.) Entering a Remote Distress Sequence if the handshake protocol with the alert device is established within a Monitoring Handshake Response Time, where the Remote Distress Sequence comprises the steps of:
A.) Transmitting the Outbound Distress Data through the Communicating Means;
B.) Transmitting the Video Feed stored in the Memory Circuits through the Communicating Means;
C.) Transmitting the Video Feed through the Communicating Means;
D.) Receiving the Inbound Alert Data through the Communicating Means;
E.) Having the Central Controller direct the Engine Sub-Controller based on the Inbound Alert Data; and
F.) Having the Central Controller reset the Distress Event Monitoring Device if the Resetting Means is activated; and
iv.) Entering an On-Board Distress Sequence if the handshake protocol with the alert device is not established within the Monitoring Handshake Response Time, where the On-Board Distress Sequence comprises the steps of:
A.) Having the Central Controller determine Rescue Response Procedures;
B.) Having the Central Controller direct the Engine Sub-Controller; and
C.) Having the Central Controller reset the Distress Event Monitoring Device if the Resetting Means is activated.

31. An Enhanced Distress Event Monitoring Method for rescuing a life form inside of a vehicle, using the Distress Event Monitoring Device in Claim the Enhanced Distress Event Monitoring Method comprising the steps of:
a.) Having the Surveillance Camera monitor the inside of the vehicle;
b.) Having the Vehicle Status Sensor Set monitor the inside of the vehicle;
c.) Having the Surveillance Camera communicate the Video Feed to the Central Controller;
d.) Having the GPS Locator communicate the GPS Location Data to the Central Controller; and
e.) Entering a Car Distress Sequence when the Indicating Means is activated, where the Car Distress Sequence comprising the steps of:
i.) Attempting to establish a handshake protocol with the alert device;
ii.) Entering a Remote Distress Sequence if the handshake protocol with the alert device is established within a Monitoring Handshake Response Time, where the Remote Distress Sequence comprises the steps of:
A.) Transmitting the Outbound Distress Data through the Communicating Means;
B.) Transmitting the Video Feed through the Communicating Means;
C.) Receiving the Inbound Alert Data through the Communicating Means;
D.) Having the Central Controller direct the Rescue Response Procedures based on the Inbound Alert Data; and
E.) Having the Central Controller reset the Distress Event Monitoring Device if the Resetting Means is activated;
iii.) Entering an On-Board Distress Sequence if the handshake protocol with the alert device is not established within the Monitoring Handshake Response Time, where the On-Board Distress Sequence comprises the steps of:
A.) Having the Central Controller determine Rescue Response Procedures;
B.) Having the Central Controller direct the Rescue Response Procedures; and
C.) Having the Central Controller reset the Distress Event Monitoring Device if the Resetting Means is activated.

32. An Advanced Distress Event Monitoring Method for rescuing a life form inside of a vehicle, using the Distress Event Monitoring Device in claim 28, the Advanced Distress Event Monitoring Method comprising the steps of:
a.) Having the Surveillance Camera monitor the inside of the vehicle;
b.) Having the Vehicle Status Sensor Set monitor the inside of the vehicle;
c.) Having the Surveillance Camera communicate the Video Feed to the Central Controller;
d.) Having the GPS Locator communicate the GPS Location Data to the Central Controller; and
e.) Entering a Car Distress Sequence when the Indicating Means is activated, where the Car Distress Sequence comprises the steps of:
i.) Having the Central Controller store the Video Feed in the Memory Circuits;
ii.) Attempting to establish a handshake protocol with the alert device;
iii.) Entering a Remote Distress Sequence if the handshake protocol with the alert device is established within a Monitoring Handshake Response Time, where the Remote Distress Sequence comprises the steps of:
A.) Transmitting the Outbound Distress Data through the Communicating Means;
B.) Transmitting the Video Feed stored in the Memory Circuits through the Communicating Means;
C.) Transmitting the Video Feed through the Communicating Means;
D.) Receiving the Inbound Alert Data through the Communicating Means;
E.) Having the Central Controller direct the Rescue Response Procedures based on the Inbound Alert Data; and
F.) Having the Central Controller reset the Distress Event Monitoring Device if the Resetting Means is activated; and
iv.) Entering an On-Board Distress Sequence if the handshake protocol with the alert device is not established within the Monitoring Handshake Response Time, where the On-Board Distress Sequence comprises the steps of:
A.) Having the Central Controller determine Rescue Response Procedures;
B.) Having the Central Controller direct the Rescue Response Procedures; and
C.) Having the Central Controller reset the Distress Event Monitoring Device if the Resetting Means is activated.

33. The Human Supervised Monitoring Device according to claim 16, wherein the Means for Detecting a Life Form comprises a Second Detecting Means.

34. The Human Supervised Monitoring Device according to claim 16, wherein the Means for Detecting a Life Form comprises a Third Detecting Means.

35. The Human Supervised Monitoring Device according to claim 16, the Human Supervised Monitoring Device further comprising:
a.) Life Form Recognition Data,
b.) wherein the Means for Detecting a Life Form comprises a Fourth Detecting Means,
c.) where the Fourth Detecting Means outputs the Life Form Recognition Data,
d.) wherein the Outbound Alert Data further comprises the Life Form Recognition Data.

36. The Distress Event Monitoring Device according to claim 28, wherein the Means for Detecting a Life Form comprises a Second Detecting Means.

37. The Distress Event Monitoring Device according to claim 28, wherein the Means for Detecting a Life Form comprises a Third Detecting Means.

38. The Distress Event Monitoring Device according to claim 28, the Human Supervised Monitoring Device further comprising:
a.) Life Form Recognition Data,
b.) wherein the Means for Detecting a Life Form comprises a Fourth Detecting Means,
c.) where the Fourth Detecting Means outputs the Life Form Recognition Data,
d.) wherein the Outbound Alert Data further comprises the Life Form Recognition Data.

39. An Improved Human Supervised Method for detecting, verifying and rescuing a

35. m inside of a vehicle, using the Human Supervised Monitoring Device in claim 35, the Improved Human Supervised Method comprising the steps of:
a.) Having the Vehicle Status Sensor Set monitor the inside of the vehicle;
b.) Having the Internal Temperature Sensor communicate the Internal Temperature Data to the Central Controller;
c.) Having the GPS Locator communicate the GPS Location Data to the Central Controller;
d.) Having the Surveillance Camera monitor the inside of the vehicle;
e.) Having the Surveillance Camera communicate the Video Feed to the Central Controller;
f.) Having the Central Controller evaluate the Internal Temperature Data;
g.) Having the Fourth Detecting Means evaluate the Video Feed; and
h.) Entering a Life Form Confirmation Sequence when the Central Controller determines that the Internal Temperature Data has reached a threshold and the Fourth Detecting Means detects the life form, where the Life Form Confirmation Sequence comprises the steps of:
i.) Attempting to establish a handshake protocol with the alert device;
ii.) Having the Central Controller store Video Feed in the Memory Circuits;
iii.) Entering a Remote Rescue Sequence if the handshake protocol with the alert device is established within a Monitoring Handshake Response Time, where the Remote Rescue Sequence comprises the steps of:
A.) Having the Fourth Detecting Means output the Life Form Recognition Data;
B.) Transmitting the Outbound Alert Data through the Communicating Means;
C.) Transmitting the Video Feed stored in the Memory Circuits through the Communicating Means;
D.) Transmitting the Video Feed through the Communicating Means;
E.) Receiving the Inbound Alert Data through the Communicating Means;
F.) Having the Central Controller direct the Engine Sub-Controller based on the Inbound Alert Data;
G.) Having the Central Controller direct the Air Conditioning Sub-Controller based on the Inbound Alert Data; and
H.) Having the Central Controller reset the Human Supervised Monitoring Device if the Resetting Means is activated; and
iv.) Entering an On-Board Rescue Sequence if the handshake protocol with the alert device is not established within the Handshake Response Time, where the On-Board Rescue Sequence comprises the steps of:
A.) Having the Fourth Detecting Means output the Life Form Recognition Data;
B.) Having the Central Controller determine Rescue Response Procedures;
C.) Having the Central Controller direct the Engine Sub-Controller;
D.) Having the Central Controller direct the Air Conditioning Sub-Controller; and
E.) Having the Central Controller reset the Human Supervised Monitoring Device when the Resetting Means is activated.

40. An Advanced Distress Event Monitoring Method for rescuing a life form inside of a

38. using the Distress Event Monitoring Device in claim 38, the Advanced Distress Event Monitoring Method comprising the steps of:
a.) Having the Surveillance Camera monitor the inside of the vehicle;
b.) Having the Vehicle Status Sensor Set monitor the inside of the vehicle;
c.) Having the Surveillance Camera communicate the Video Feed to the Central Controller;
d.) Having the GPS Locator communicate the GPS Location Data to the Central Controller; and
e.) Entering a Car Distress Sequence when the Indicating Means is activated, where the Car Distress Sequence comprises the steps of:
i.) Having the Central Controller store the Video Feed in the Memory Circuits;
ii.) Attempting to establish a handshake protocol with the alert device;
iii.) Entering a Remote Distress Sequence if the handshake protocol with the alert device is established within a Monitoring Handshake Response Time, where the Remote Distress Sequence comprises the steps of:
A.) Having the Fourth Detecting Means output the Life Form Recognition Data;
B.) Transmitting the Outbound Distress Data through the Communicating Means;
C.) Transmitting the Video Feed stored in the Memory Circuits through the Communicating Means;
D.) Transmitting the Video Feed through the Communicating Means;
E.) Receiving the Inbound Alert Data through the Communicating Means;
F.) Having the Central Controller direct the Rescue Response Procedures based on the Inbound Alert Data; and
G.) Having the Central Controller reset the Distress Event Monitoring Device if the Resetting Means is activated; and
iv.) Entering an On-Board Distress Sequence if the handshake protocol with the alert device is not established within the Monitoring Handshake Response Time, where the On-Board Distress Sequence comprises the steps of:
A.) Having the Fourth Detecting Means output the Life Form Recognition Data;
B.) Having the Central Controller determine Rescue Response Procedures;
C.) Having the Central Controller direct the Rescue Response Procedures; and
D.) Having the Central Controller reset the Distress Event Monitoring Device if the Resetting Means is activated.

41. The Human Supervised Monitoring Device according to claim 16, wherein the Means for Detecting a Life Form comprises a Face Detection Algorithm.

42. The Human Supervised Monitoring Device according to claim 16, wherein the Means for Detecting a Life Form comprises a Face Detection Algorithm (116) and a Shape Detection Algorithm.

43. The Human Supervised Monitoring Device according to claim 16, the Human Supervised Monitoring Device further comprising:
a.) Life Form Recognition Data,
b.) wherein the Means for Detecting a Life Form comprises a Face Detection Algorithm and a Shape Detection Algorithm,
c.) where the Means for Detecting a Life Form outputs the Life Form Recognition Data,
d.) wherein the Outbound Alert Data further comprises the Life Form Recognition Data.

44. The Distress Event Monitoring Device according to claim 28, wherein the Means for Detecting a Life Form comprises a Face Detection Algorithm.

45. The Distress Event Monitoring Device according to claim 28, wherein the Means for Detecting a Life Form comprises a Face Detection Algorithm (116) and a Shape Detection Algorithm.

46. The Distress Event Monitoring Device according to claim 28, the Human Supervised Monitoring Device further comprising:
a.) Life Form Recognition Data,
b.) wherein the Means for Detecting a Life Form comprises a Face Detection Algorithm and a Shape Detection Algorithm,
c.) where the Means for Detecting a Life Form outputs the Life Form Recognition Data,
d.) wherein the Outbound Alert Data further comprises the Life Form Recognition Data.
